(19) United States
(12) Patent Application Publication
(10) Pub. No.: US 2026/0004184 A1
(43) Pub. Date: Jan. 1, 2026

(54) PRE-TRAINED MACHINE-LEARNED SCENARIO DATA DIFFICULTY METRIC FOR VEHICLE CONTROL

(71) Applicant: Zoox, Inc., Foster City, CA (US)

(72) Inventors: Seth Benjamin Aaron, Pasadena, CA (US); Andrew Scott Crego, Palo Alto, CA (US); Alec Jacob Farid, Commack, NY (US); Peter Scott Schleede, El Dorado Hills, CA (US); Nathan David Shemonski, San Mateo, CA (US)

(21) Appl. No.: 18/759,305

(22) Filed: Jun. 28, 2024

(51) Int. Cl. G06N 20/00; B60W 60/00

(52) U.S. Cl. CPC G06N 20/00; B60W 60/0027

(57) ABSTRACT

A pre-trained machine-learned model, pre-generated clusters determined from embeddings generated by the machine-learned model, and/or difficulty metric(s) determined from simulation and associated with the clusters may be transmitted to and used on a vehicle. The machine-learned model may use sensor data to generate an embedding or a difficulty metric characterizing a current scenario encountered by the vehicle and the vehicle may alter operation of the vehicle based on the difficulty metric or difficulty metric(s) for the cluster associated with the embedding.

### BACKGROUND

Running simulations of scenarios may provide a valuable method for testing autonomous systems and/or machine-learned model pipelines, such as those incorporated in autonomous vehicles. However, effectively testing an autonomous vehicle component may require thousands or millions of simulations, which may take an enormous amount of computing bandwidth and time. This allocation of computing resources may increase the amount of time it takes to verify an update to a component, which may decrease the safety of the autonomous vehicle, and prevent other components from being tested.

### BRIEF DESCRIPTION OF THE DRAWINGS

The detailed description is described with reference to the accompanying figures. In the figures, the left-most digit(s) of a reference number identify the figure in which the reference number first appears. The same reference numbers in different figures indicate similar or identical items.

FIG. 1 illustrates an example scenario including an autonomous vehicle operating that may be modeled in a simulated scenario to validate the safety and/or efficacy of component(s) of the autonomous vehicle.

FIG. 2 illustrates a block diagram of an example architecture for generating simulations to validate and/or certify component(s) of an autonomous vehicle and/or to transmit difficulty metrics to a vehicle that may be used to streamline vehicle computations according to the techniques discussed herein.

FIG. 3 illustrates a block diagram of an example architecture for generating a difficulty metric for a first scenario.

FIG. 4 illustrates a block diagram for an example process for clustering log data and sampling log data to be simulated using difficulty metrics determined for the log data, while tracking the confidence in performance metrics determined for the simulations and adjusting an overall performance metric due to the reduced amount of log data used.

FIG. 5 illustrates a flow diagram of an example process for generating simulations to validate and/or certify component(s) of an autonomous vehicle according to the techniques discussed herein.

FIG. 6 illustrates a flow diagram of an example process for controlling operation of a vehicle using the encoder of the machine-learned model discussed herein that may also be used for generating an embedding of sensor and/or perception data.

### DETAILED DESCRIPTION

Techniques for accurately validating component(s) of an autonomous vehicle or the entire autonomous vehicle may comprise determining, via simulation, a performance metric for the component or operation of the vehicle that may be based at least in part on a number of times a simulation of operation of the vehicle or component results in an adverse event, the severity of such events, and the like. Such an adverse event may include, for example, a contact with an object, failing to detect an object, pausing, stopping, altering or ending a mission or route, idling, failing to determine an operation to control the vehicle, not complying with stated rules or policies, or the like. The performance metric may indicate how frequently such an adverse event occurs per 1,000 miles (e.g., simulated) and/or a difference of the performance metric in comparison to a baseline performance metric, such as a prior version of the component being validated. Simulations may be based on log data samples from real world driving events to, for example, accurately model scenarios that may occur during real world driving.

The techniques discussed herein may overcome several increasing problems with using simulation to test and/or validate component(s) of an autonomous vehicle. For example, the number of simulations it takes to determine performance metric(s) indicating the safety and efficacy of a component may be in the thousands, hundreds of thousands, or millions of simulations to achieve a reasonable confidence interval (e.g., ≥90%, ≥95%, ≥98%, ≥99%). A confidence interval may be a likelihood (e.g., a posterior probability) that the safety or efficacy metric correctly characterizes operation of the vehicle or operation of the vehicle when it uses the component as part of its operations. In some examples, the component may be tested to validate that an adverse event is avoided using a simulation component. A confidence interval may be determined based at least in part on the simulations run and/or a variance of the simulation outcomes associated therewith, where the confidence interval may indicate a likelihood that the performance metric is correct.

The techniques discussed herein may comprise a machine-learned model trained to determine a difficulty metric associated with a scenario for simulation. This difficulty metric may be used to select, for simulation, a subset of the available scenarios. This may increase the likelihood that difficult scenarios are chosen for simulation and may allow the number of simulations executed to be reduced while maintaining or increasing the confidence interval. The techniques may improve the testing and/or training of one or more components of the autonomous vehicle (e.g., a localization component, a perception component, a planning component) and may thereby improve the accuracy thereof and the safety and efficacy of operation of the autonomous vehicle. For example, the techniques may allow a newly updated component to be tested/validated before implementing it on the vehicle instead of only finding out then that there's a problem with the updated component that may reduce the safety and efficacy of the vehicle.

Moreover, the techniques may increase the confidence interval without increasing the number of scenarios run and/or may decrease the number of scenarios to satisfy (i.e., meet or exceed) a threshold confidence. Ultimately, the techniques may decrease the time and computational resources required to test and/or validate a component of a vehicle. As autonomous vehicles collect log data and transmit it to a remote computing device for simulation (e.g., to test and/or validate operations of the autonomous vehicle and/or modifications thereto), it may become computationally infeasible to simulate operation of the autonomous vehicle using all of the log data. However, reducing the log data simulated may unintentionally remove or reduce log data that would be critical to testing and/or verifying component(s) of the vehicle. The techniques discussed herein allow the log data to be reduced while preserving the use of different types of scenarios that appear in the log data, thereby ensuring the fidelity of the metrics used to test and/or validate operations of component(s) of the autonomous vehicle. Namely, the techniques may comprise the machine-learned model that determines a difficulty metric for individual scenarios and/or clusters that may be used to select scenarios that may be difficult for a vehicle to traverse for any of a variety of reasons.

In some instances, the techniques may enable live validation-if a developer or engineer makes a change to one of the components of the autonomous vehicle, the techniques described herein may notify the developer or engineer whether the change negatively affected the performance metric(s) associated with the component and/or whether the component would continue to be validated. A component may be validated if the performance metric and/or confidence interval determined from the simulation satisfies a safety and/or efficacy criterion. For example, determining that an efficacy performance metric satisfies an efficacy criterion may include determining that simulated vehicle paused, stopped, diverted, altered or ended a mission or route, idled, failed to determine an operation to control the vehicle, or the like less than a threshold number of times per 1,000 miles (or any other distance or operation time threshold, such as per 100 miles, per 100 operating hours, per 1,000 operating hours) with a confidence that meets or exceeds a threshold confidence. Determining that a safety performance metric satisfies a safety criterion may include determining that the simulated vehicle contacted an object, failed to detect an object, or the like less than a threshold number of times per 1,000 miles (or any other distance or operation time threshold, such as per 100 miles, per 100 operating hours, per 1,000 operating hours) with a confidence that meets or exceeds a threshold confidence.

The techniques discussed herein may include modifying the way a set of scenario data is chosen for simulation and may reduce the total number of simulations run to determine performance metric(s) at a confidence interval that meets or exceeds a threshold confidence interval. In some examples, the log data discussed herein may be the scenario data. The first scenario data may comprise a series of sensor data, perception data, map data, and/or the like over a segment of time. Map data may indicate roadway data and/or map data for a segment, such as a geometry and/or classification of a roadway (e.g., a directionality of the roadway, a portion of the roadway being associated with a crosswalk or signage, an indication that a portion of the roadway is controlled by signage); and/or static object(s) in the environment, such as fixtures that do not change states. For examples, traffic lights may be detected by the perception component as an object detection and included in the perception data instead of or in addition to an indication of a traffic light post in the map data, whereas a traditional stop sign may be indicated in the map data (and may be confirmed by an object detection generated by the perception component and indicated as being a static object, in some examples).

In some examples, the techniques discussed herein may comprise determining a subset of scenario data for simulation based purely on difficulty metrics determined for the subset of scenario (e.g., selecting the top n % of scenarios ranked by difficulty metric, where n is a positive integer), based on a mix of selection using the top n % of scenarios and another portion sampled from clusters, by using the difficulty metric(s) as part of the cluster generation and sampling from the clusters, and/or based at least in part on determining sampling weight(s) for the cluster(s) using the difficult metric(s) associated therewith.

In some examples, a difficulty metric may comprise a single or multiple difficulty metrics for a scenario, such as a likelihood (e.g., a posterior probability) that a simulated vehicle will contact an object during simulation of the scenario, a likelihood that operation of the simulated vehicle during simulation of the scenario will result in a comfort event, a likelihood that operation of the simulated vehicle during simulation of the scenario will be degraded, and/or the like. A comfort event may comprise operation of the simulated vehicle such that a lateral, longitudinal, and/or total acceleration or jerk of the vehicle meets or exceeds a threshold acceleration or threshold jerk, respectively. Degraded operation may comprise the vehicle idling, pausing, or stopping for longer than a threshold time duration, failing to generate a trajectory to control the vehicle, transmitting a request for teleoperations assistance, and/or the like. In some examples, the difficulty metric may additionally or alternatively comprise an estimated length of time and/or an estimated amount of computational resources required to run the simulation.

In an example where clustering is used as part of determining the subset of scenario data to simulate, a first scenario may be provided as input to a machine-learned model (e.g., an encoder) that determines an embedding that represents the first scenario data in an embedding space and differentiates the first scenario data from other instances of scenario data. The embeddings generated for the set of scenario data (including the first scenario data) may be downsampled to simulate less than the entire set of scenario data.

For example, once embeddings have been generated for up to all of the scenario data in the set, the embeddings generated for the scenario data may be clustered. Clustering the embeddings may include using k-means, k-medians, agglomerative clustering, mean shift clustering, density-based spatial clustering (DBSCAN), t-distributed stochastic neighbor embedding (t-SNE), or the like to determine k number of clusters of the set of scenario data, where k is a positive integer. In some examples, k may be determined based at least in part on a previous batch of simulations used to test a component and may change depending on the particular component being tested. Additionally or alternatively, k may be a learned parameter as part of training the machine-learned model discussed herein. Note that, as new log data is received, the clustering may be wholly re-determined or, in other examples, the existing clusters may be modified based at least in part on the new scenario data. Additionally or alternatively, if an embedding determined for the new log data is projected into a cluster that includes more than a threshold number of embeddings already, the log data and its embedding may be marked as archived, otherwise suppressed from use, or deleted.

In an example where the difficulty metric associated with a first scenario is used as part of clustering, the difficulty metric may be indicated as a value or vector that may be associated with the embedding representing the first scenario. For example, the difficulty metric may be paired with, concatenated to, averaged with, or used by a machine-learned model to generate a new embedding based at least in part on the difficulty metric and the embedding. Regardless, the difficulty metric may be used, in association with the embedding, to determine a cluster and/or a cluster membership of the first scenario.

The techniques may comprise determining a subset of the set of scenario data to simulate based at least in part on sampling embeddings (and their associated scenario data) from the clusters. This sampling may comprise uniform sampling across the clusters (without replacement) (e.g., sampling a same number or percentage of embeddings from each cluster) or sampling according to custom sampling percentages or numbers. For example, clusters may be uniformly sampled except for one or more clusters having a custom sampling method associated therewith. These cluster(s) may have been identified as being associated with rare scenarios or may have a performance metric that is below a threshold number. For example, the techniques discussed herein may comprise determining a performance metric in association with the simulation(s) conducted using scenario data sampled from a particular cluster. If this performance metric is below a threshold performance metric, the number of samples taken from that cluster may be increased compared to the uniform sampling arrangement. Additionally or alternatively, some cluster(s) may be sampled less than the typical uniform sampling rate (e.g., such as when the difficulty metric(s) associated therewith are below a threshold difficulty metric), such as for those cluster(s) associated with normative driving. Such cluster(s) may be associated with a performance metric that meets or exceeds an upper performance metric threshold that may be greater than the threshold performance metric for validating a component.

Simulating one of the samples of scenario data may comprise providing the sampled scenario data as input to component(s) of the vehicle, which may include directly providing the scenario data as input to the component being tested, providing the scenario data to component(s) upstream from the component being tested, and/or using the scenario data to generate a simulation of the scenario data, such as a two- or three-dimensional computer simulation of the scenario data and using that simulation as input to the component being tested and/or component(s) upstream from the component being tested.

After running the simulation, any adverse events that occurred during the simulation may be counted, a number of miles driven and/or operation time during the simulation may be determined, and/or an updated confidence score may be determined. In some examples, determining a confidence score may start once a minimum number of simulations have been run. Determining the confidence score may be based at least in part on a variance determined based at least in part on an outcome of the simulation associated with the first set of scenario data and/or any prior sets of scenario data used for simulation. In some examples, sampling from the clusters and simulating may be stopped once a minimum number of simulations has been reached, a minimum number of simulated miles driven by the vehicle has been reached, a minimum number of samples has been determined from each cluster or from cluster(s) with an elevated minimum number (e.g., a cluster associated with a performance metric that indicates a rate of event occurrences that meets or exceeds a threshold rate) and/or the confidence score meets or exceeds a threshold confidence score.

The techniques may include determining a total/overall performance metric based at least in part on the performance metrics determined for each simulation. In some examples, determining the overall performance metric may include weighting performance metrics determined based on scenario data from a same cluster using a weight determined for that cluster. The weight may be determined based at least in part on a number of samples taken from the cluster and/or a total number of sets of scenario data associated with the cluster. The overall performance metric may comprise a weighted combination (e.g., a weighted average, a weighted sum model, weighted linear combination) of the performance metrics of the different clusters. In some examples, where multiple performance metrics were determined, multiple overall performance metrics may also be determined (e.g., one for vehicle pauses, one for object contacts, and the like). Additionally or alternatively, the techniques may comprise determining average or weighted average performance metric(s) for a cluster and/or any attribute of the scenario data, such as a real-world location, maneuver type executed by the vehicle, object behavior, and/or the like. In such an example, performance metrics determined for any simulations run using scenario data associated with the cluster or attribute may be used to determine such an average or weighted average performance metric.

The techniques may additionally or alternatively include determining whether to validate the component based at least in part on determining whether the overall performance metric satisfies a safety and/or efficacy criterion (according to the thresholds discussed above). For example, determining that an overall performance metric for object contacts may comprise determining that the overall performance metric indicates that the autonomous vehicle is predicted to contact an object at a rate per mile or operation time that is less than a threshold rate, such as the rate at which the average human driver contacts an object or a rate that is ten times less than a rate at which the average human driver contacts an object. If the overall performance metric(s) satisfy the safety criterion and/or efficacy criterion, the component may be implemented by an autonomous vehicle and used as part of controlling an operation of the autonomous vehicle. This may include transmitting the component to the autonomous vehicle for installation or installing physical hardware in the autonomous vehicle. However, if the performance metric(s) fail to satisfy the safety criterion and/or efficacy criterion, the component may be indicated as failing the validation test and the autonomous vehicle may be controlled using a previous configuration and/or a previous version of the component. Moreover, the techniques may be used to validate the vehicle is safe and effective at operating in a set of condition(s) (e.g., in a geographical area, during an environmental condition such as night/day, rain/fog/facing sun).

The techniques discussed herein may additionally or alternatively reduce the amount of log data transmitted by an autonomous vehicle, increasing available network bandwidth, and decreasing network latency and computational resource use. This may also reduce the amount of storage and processing at a remote computing device that receives the log data.

### Example Scenario

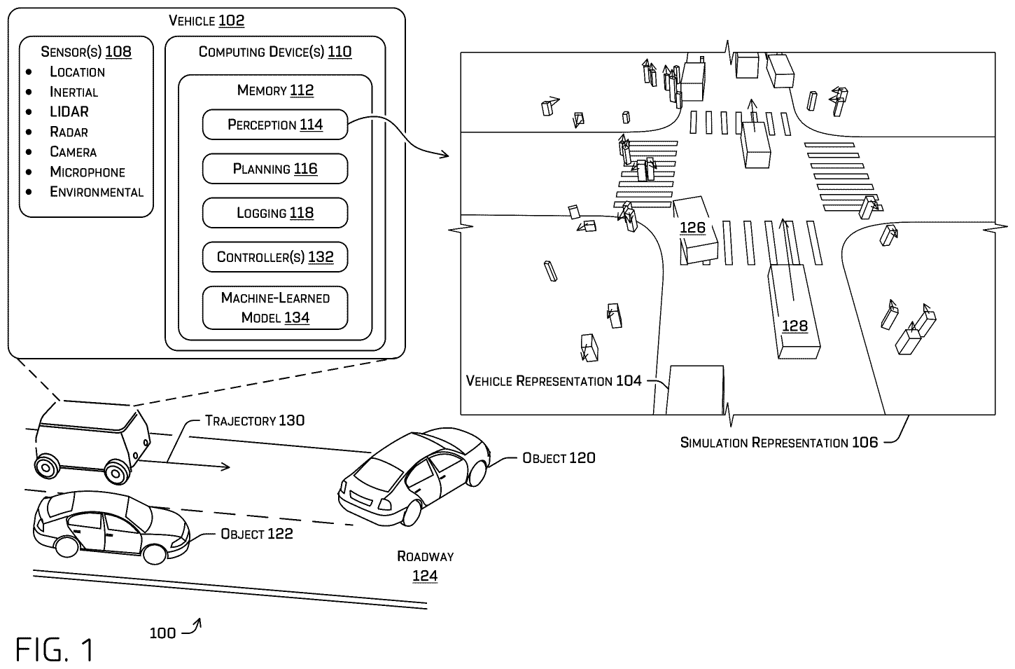

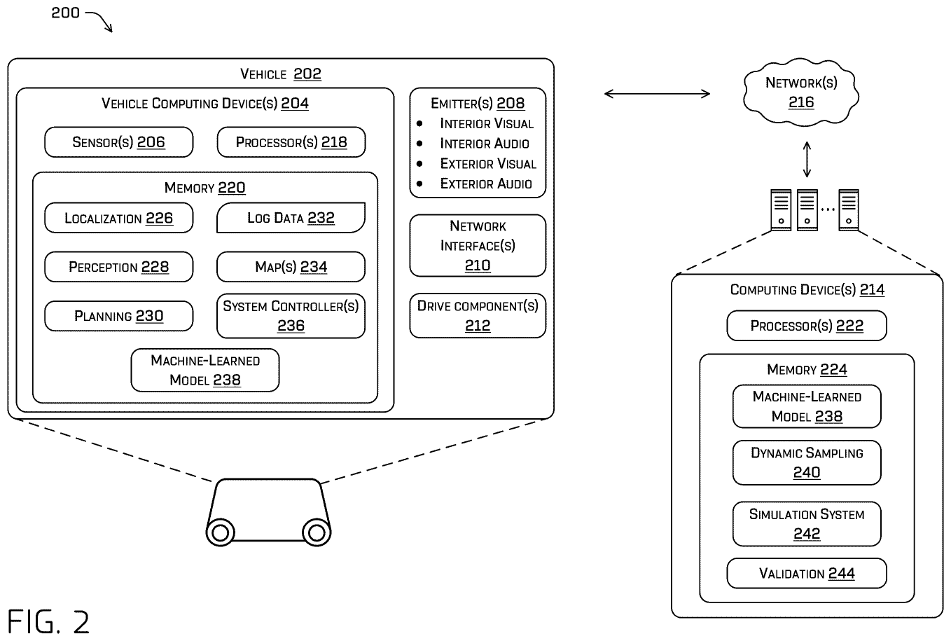

FIG. 1 illustrates an example scenario 100 including a vehicle 102. In some examples, the example scenario 100 may be a real-world scenario and/or the example scenario 100 may be a representation of a real-world scenario modeled as a simulated scenario. In examples where the example scenario 100 is a simulated scenario, the example scenario 100 may be determined based at least in part on scenario data that may be used to identify characteristic(s) of the simulation and/or execute the simulation. For example, the simulation may be based at least in part on log data received from one or more autonomous vehicles. The log data may be based at least in part on sensor data received at an autonomous vehicle, perception data generated by a perception component, and/or instructions generated by a planning component. In some examples, the autonomous vehicle may store the log data and/or periodically transmit the log data to a remote computing device (illustrated in FIG. 2).

In some instances, the vehicle 102 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the vehicle 102 may be a fully or partially autonomous vehicle having any other level or classification. It is contemplated that the techniques discussed herein may apply to more than robotic control, such as for autonomous vehicles. For example, the techniques discussed herein may be applied to mining, manufacturing, augmented reality, etc. Moreover, even though the vehicle 102 is depicted as a land vehicle, vehicle 102 may be a spacecraft, watercraft, and/or the like. In some examples, vehicle 102 may be represented in a simulation as a simulated vehicle, such as the vehicle representation 104 in simulation representation 106. For simplicity, the discussion herein does not distinguish between a simulated vehicle and a real-world vehicle. References to a “vehicle” may therefore reference a simulated and/or a real-world vehicle unless explicitly referred to as one or the other.

According to the techniques discussed herein and an example where scenario 100 is a real-world example, the vehicle 102 may receive sensor data from sensor(s) 108 of the vehicle 102. For example, the sensor(s) 108 may include a location sensor (e.g., a global positioning system (GPS) sensor), an inertia sensor (e.g., an accelerometer sensor, a gyroscope sensor, etc.), a magnetic field sensor (e.g., a compass), a position/velocity/acceleration sensor (e.g., a speedometer, a drive system sensor), a depth position sensor (e.g., a lidar sensor, a radar sensor, a sonar sensor, a time of flight (ToF) camera, a depth camera, and/or other depth-sensing sensor), an image sensor (e.g., a camera), an audio sensor (e.g., a microphone), and/or environmental sensor (e.g., a barometer, a hygrometer, etc.). In some examples, a simulated sensor may correspond with at least one of the sensor(s) 108 on the vehicle 102 and in a simulation, one or more of sensor(s) 108 may be simulated. In some examples, the position of a simulated sensor may correspond with a relative position of one of the sensor(s) 108 to the vehicle 102 and/or vehicle representation 104.

The sensor(s) 108 may generate sensor data, which may be received by computing device(s) 110 associated with the vehicle 102. However, in other examples, some or all of the sensor(s) 108 and/or computing device(s) 110 may be separate from and/or disposed remotely from the vehicle 102 and data capture, processing, commands, and/or controls may be communicated to/from the vehicle 102 by one or more remote computing devices via wired and/or wireless networks. During a simulation, the sensor data may be simulated based at least in part on a synthetic environment generated by the simulation system.

Computing device(s) 110 may comprise a memory 112 storing a perception component 114, a planning component 116, and/or a logging component 118. Note that, in some examples, the computing device(s) 110 may additionally or alternatively store a prediction component, map data, and/or localization component. The prediction component may be part of the perception component 114 and it may determine a predicted position, orientation, velocity, acceleration, and/or state (e.g., aperture state, blinker state) associated with an object. The localization component may comprise software and/or hardware system(s) for determining a pose (e.g., position and/or orientation) of the vehicle 102 relative to one or more coordinate frames (e.g., relative to the environment, relative to a roadway and/or static object(s) indicated in map data, relative to an inertial direction of movement associated with the autonomous vehicle). The localization component may output at least part of this data to the perception component 114, which may output at least some of the localization data and/or use the localization data as a reference for determining at least some of the perception data.

In general, the perception component 114 may determine what is in the environment surrounding the vehicle 102 (or during a simulation what is in the simulated environment) and the planning component 116 may determine how to operate the vehicle 102 (or control the vehicle representation 104 in a simulation) according to information received from the localization component and/or the perception component 114. The prediction component, the localization component, the perception component 114, and/or the planning component 116 may include one or more machine-learned (ML) models and/or other computer-executable instructions.

In some examples, the localization component and/or the perception component 114 may receive sensor data from the sensor(s) 108 and/or simulated data from a simulation system. In some examples, the localization component and/or perception component 114 may comprise a pipeline of hardware and/or software, which may include one or more GPU(s), ML model(s), Kalman filter(s), and/or the like. In some instances, the perception component 114 may determine data related to objects (or simulated objects) in the vicinity of the vehicle 102 (e.g., classifications associated with detected objects, instance segmentation(s), tracks), route data that specifies a destination of the vehicle, global map data that identifies characteristics of roadways (e.g., features detectable in different sensor modalities useful for localizing the autonomous vehicle), map data that identifies characteristics detected in proximity to the vehicle (e.g., locations and/or dimensions of the roadway, roadway classification(s) (e.g., directionality associated with a portion of the roadway, crosswalk locations, controlled intersection type, signage type and location), buildings, trees, fences, fire hydrants, and any other feature detectable in various sensor modalities), etc. In some examples, the objects surrounding the vehicle 102 may be simulated objects of a simulated environment. The data produced by the perception component 114 may be collectively referred to as “perception data.” Once the perception component 114 has generated perception data, the perception component 114 may provide the perception data to the planning component 116.

In some examples, simulations to validate a particular component may provide simulation data directly to that component. For example, to test the planning component 116, instead of providing simulated sensor data to the perception component 114, simulated perception data may be provided to the planning component 116 directly. This simulated perception data may be ground truth data, in at least one example. Additionally or alternatively, the vehicle system(s) may be tested as a whole by providing simulated sensor data to the localization component and/or perception component (e.g., to the system(s) that would be root nodes/furthest upstream during normative operation rather than providing simulated data to an intermediate component in the vehicle system).

During a real-world scenario, perception component 114 may detect object 120, a vehicle in the depicted example; object 122, another vehicle in the example; and/or characteristics of the roadway 124. During a simulation, perception component 114 may detect representation 126 and/or representation 128, where representation 126 may represent object 120 and representation 128 may represent object 122 in a simulation that reproduces the real-world scenario illustrated. Note that the depicted simulation representation 106 is a simplified simulation where different objects are represented as boxes and the depicted simulation representation 106 additionally includes additional simulated objects representing additional vehicles and pedestrians. It is understood that, instead of or in addition to a simplified simulation, the simulation may replicate real-world appearances.

When a perception component 114 detects an object, whether real or simulated, the perception component 114 may generate an object detection, which may comprise a data structure indicating one or more characteristics of the object. For example, the object detection may indicate a region of interest (ROI) associated with the object detection (e.g., a bounding box, mask, or other indication of a portion of sensor data associated with the object); instance segmentation; semantic segmentation; a volume or area occupied by the object; a pose (e.g., position and/or orientation); velocity; acceleration; classification (e.g., vehicle, pedestrian, articulating vehicle, signage); track; confidence score(s) that any such data is accurate; etc. associated with the object. The perception component 114 may associate an object detection with a track, which may indicate that the object has been previously detected and may comprise historical perception data and/or predicted perception data associated with the object. For example, the track may associate one or more object detections associated with a same object but different times. In some examples, the track may indicate a current, historical, and/or predicted position, orientation, velocity, acceleration, and/or state associated with an object.

In some examples, the perception component 114 may comprise a prediction component that determines predicted data associated with an object, such as a predicted future position, orientation, velocity, acceleration, state, or the like. This predicted data and/or historical data associated with an object may be amalgamated with the current object detection data as a track in association with the object. In some examples, the prediction data may be additionally or alternatively based at least in part on map data or other data. In some examples, the prediction data may comprise a top-down segmentation of the environment, as described in more detail in U.S. Pat. No. 10,649,459, filed Apr. 26, 2018, which is incorporated by reference in its entirety for all purposes herein, and/or a top-down prediction associated with the environment, as described in more detail in U.S. Patent Application Publication No. 2021-0181758, filed Jan. 31, 2020, which is incorporated by reference in its entirety for all purposes herein. In some examples, the prediction data generated by such a prediction component may be part of the perception data.

The planning component 116 may determine a trajectory 130 based at least in part on the perception data and/or localization data (e.g., where the vehicle 102 is in the environment relative to a map and/or features detected by the perception component 114). For example, the planning component 116 may determine a route for the vehicle 102 from a first location to a second location; generate, substantially simultaneously and based at least in part on the perception data, a plurality of potential trajectories for controlling motion of the vehicle 102 in accordance with a receding horizon technique (e.g., 1 micro-second, half a second, 4 seconds, 8 seconds, and the like) to control the vehicle to traverse the route (e.g., in order to avoid any of the detected objects); and select one of the potential trajectories as a trajectory 130 that the vehicle 102 may use to generate a drive control signal that may be transmitted to drive components of the vehicle 102 or, in a simulation, to control the vehicle representation 104 in the simulated environment. In some examples, the trajectory 130 may be part of a series of trajectories determined by a tree search conducted by the planning component 116 based at least in part on the sensor data, perception data, prediction data, map data, and/or top-down representation, as discussed in more detail in U.S. Patent Application Pub. No. 2023/0041975, filed Aug. 4, 2021 and/or U.S. patent application Pub. Ser. No. 18/540,642, filed Dec. 14, 2023, the entirety of which is incorporated by reference herein for all purposes. FIG. 1 depicts an example of such a trajectory 130, represented as an arrow indicating a heading, velocity, and/or acceleration, although the trajectory itself may comprise instructions for controller(s) 132, which may, in turn, actuate a drive system of the vehicle 102.

For example, the planning component 116 may determine a route from a first location to a second location based at least in part on a set an intersection and/or roadway whitelist and/or blacklist. The route may identify the roadway(s), intersection(s), and/or lane(s) that the vehicle may plan to use to reach the second location from the first location. A whitelist may identify those intersections and/or roadways the vehicle 102 may use to determine a route from a first location to a second location (any roadways and/or intersections not appearing on the whitelist may not be used as part of a route); whereas, a blacklist may identify those intersections and/or roadways the vehicle 102 may not use to determine a route from a first location to a second location (any other roadways and/or intersections not appearing on the blacklist may be used). The techniques discussed herein may comprise determining a location, such as an intersection or roadway to remove from the whitelist or add to the blacklist, such as by determining that a location is associated with a performance metric that is below a threshold performance metric. The techniques may additionally or alternatively comprise removing from a whitelist or adding to a blacklist other characteristic(s) of scenario data, such as a geographical region, a roadway configuration (e.g., 6-way intersection, roadway near a particular type of building), an area with high object density, or the like.

For example, the tree search may iteratively determine different candidate actions as candidates for controlling the vehicle for each time period of a series of time periods. The prediction component, which may comprise a different machine-learned model, may determine at least a portion of a predicted trajectory for an object in the environment based at least in part on such a candidate action and the tree search may select a first candidate action associated with a first time period to use to explore further candidate actions stemming from the first candidate action at a second time period, as discussed in more detail in U.S. patent application Ser. No. 18/540,642, referenced above. In some examples, the portion of the predicted trajectory may comprise a response of the object to the candidate action since some candidate actions for controlling the vehicle may affect an operation of the object. In some examples, a cost may be determined by a cost function for each candidate action based at least in part on the predicted trajectory of the object. The prediction component may update the predicted trajectory and/or add a new portion to the predicted trajectory of an object that was determined for the first candidate action based at least in part on one of the candidate actions determined for the second time step. The tree search may repeat this process until a time horizon, distance, or target pose is achieved by the tree search. The tree search may also account for objects classified by the perception component 114 as not being relevant to operation planning by the vehicle (e.g., a machine-learned model may have generated a likelihood of such object(s) changing their behavior responsive to a candidate action of the vehicle that is below a likelihood threshold), but may use a passive prediction for those objects. In some examples, the passive prediction may be determined by the tree search using a kinematics model or neural network. However, such a passive prediction would not be based on the candidate action(s) of the vehicle.

In some examples, the machine-learned model 134 architecture discussed herein may determine an embedding associated with a predicted state of the environment (e.g., output by the prediction component), such as determined as part of a tree search responsive to a candidate trajectory for controlling the vehicle. In some examples, the techniques may comprise directly determining, by another machine-learned model based at least in part on the embedding or the raw perception data, a difficulty metric associated with the perception data and/or determining a cluster that such an embedding is located within, within a threshold distance of, or nearest to and determining a difficulty metric associated with the cluster. If this difficulty metric meets or exceeds a threshold difficulty metric, the candidate trajectory may be suppressed or down-weighted (e.g., such as by increasing a cost associated with the candidate trajectory by multiplying, by a scalar value greater than 1, a cost determined for the candidate trajectory by the tree search). Additionally or alternatively, if the difficulty metric is less than the difficulty metric threshold or a lower difficulty metric threshold, the candidate trajectory may be promoted, such as by reducing a cost associated with the candidate trajectory (e.g., by multiplying the cost by a scalar value that is less than 1).

Additionally or alternatively, the machine-learned model 134 may determine an embedding associated with a current state of the environment, as indicated by perception data and/or map data. If the embedding is associated a difficulty metric that meets or exceeds a difficulty metric threshold (e.g., such as by determining a cluster with which the embedding is associated or using a machine-learned model to determine the difficulty metric based at least in part on the embedding or the raw perception data), the techniques may comprise increasing a number of threads, cores, computation time, or other units of computation accessible to the tree search for determining a trajectory for controlling the vehicle and/or increasing a maximum number of candidate trajectories that the tree search generates and/or explores.

FIG. 1 depicts an example of a trajectory 130, represented as an arrow indicating a position, heading, velocity, and/or acceleration, although the trajectory itself may comprise instructions for a controller, which may, in turn, actuate a drive system of the vehicle 102. For example, the trajectory 130 may comprise instructions for controller(s) 132 of the autonomous vehicle 102 to actuate drive components of the vehicle 102 to effectuate a steering angle and/or steering rate, which may result in a vehicle position, vehicle orientation, vehicle velocity, and/or vehicle acceleration (or a simulated version thereof when the autonomous vehicle is being simulated). The trajectory 130 may comprise a target heading, target steering angle, target steering rate, target position, target velocity, and/or target acceleration for the controller(s) to track over a time horizon (e.g., 5 milliseconds, 10 milliseconds, 100 milliseconds, 200 milliseconds, 0.5 seconds, 1 second, 2 seconds, etc.) or a distance horizon (e.g., 1 meter, 2 meters, 5 meters, 8 meters, 10 meters). However, in a simulation, the trajectory may be used by a simulation system to control a position, orientation, velocity, acceleration, etc. of the simulated autonomous vehicle.

In some examples, the logging component 118 may determine log data comprising sensor data, perception data, scenario data, map data, and/or planning data to store and/or transmit to a remote computing device (unillustrated in FIG. 1), as well as any other message generated and or sent by the vehicle 102 during operation including, but not limited to, control messages, error messages, etc. In some examples, a real-world vehicle 102 may transmit the log data to a remote computing device(s). The remote computing device(s) may identify one or more scenarios based at least in part on the log data, which may also comprise defining a scenario and/or scenario data. For example, the remote computing device(s) may determine characteristics of a scenario comprising a geographical region associated with the log data (e.g., a city, neighborhood, or other sub-region of a geographical region, such as may be defined by a user-defined shape or street(s) or other geographical features that bound the sub-region), a label provided by a user, an environmental layout, a number, classification, and/or a position of object(s) in the environment and/or associate this definition with one or more portions of log data associated with that scenario. Additionally or alternatively, the characteristics may comprise object data indicated by perception data of the scenario, such as object data indicating at least one of a position of an object, a heading of the object, a classification of the object, a relative position of the object to the vehicle, or a movement classification of the object. Note that, although simulation scenarios may be determined from log data, they may also be defined based at least in part on user input, procedurally generated, or the like. In some examples, the scenario data may further identify various state data that may be determined based at least in part on sensor data, perception data, map data and/or the like. For example, the scenario data may comprise perception data, prediction data, map data (e.g., roadway locations, shapes, labels (e.g., one way lane, indication of the extents of a lane, yield area, stop line), and/or extents; static object locations and/or extents; static object type(s); etc.), and/or localization data. In some examples, the scenario data may further comprise map data and/or internal state data associated with the vehicle 102, such as intermediate software and/or hardware outputs, flags, pub-sub (publisher/subscriber) message(s), and/or the like. The scenario data may additionally or alternatively may comprise controls generated for controlling the vehicle 102. For example, the scenario data may comprise the steering angle, steering rate, velocity, and/or acceleration instructions for controlling the vehicle 102 for a time horizon associated with sensor data and/or other scenario data.

### Example System

FIG. 2 illustrates a block diagram of an example system 200 that implements the techniques discussed herein. In some instances, the example system 200 may include a vehicle 202, which may represent the vehicle 102 in FIG. 1. In some instances, the vehicle 202 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the vehicle 202 may be a fully or partially autonomous vehicle having any other level or classification. Moreover, in some instances, the techniques described herein may be usable by non-autonomous vehicles as well.

The vehicle 202 may include a vehicle computing device(s) 204, sensor(s) 206, emitter(s) 208, network interface(s) 210, and/or drive component(s) 212. Vehicle computing device(s) 204 may represent computing device(s) 110 and sensor(s) 206 may represent sensor(s) 108. The system 200 may additionally or alternatively comprise computing device(s) 214.

In some instances, the sensor(s) 206 may represent sensor(s) 108 and may include lidar sensors, radar sensors, ultrasonic transducers, sonar sensors, location sensors (e.g., global positioning system (GPS), compass, etc.), inertial sensors (e.g., inertial measurement units (IMUs), accelerometers, magnetometers, gyroscopes, etc.), image sensors (e.g., red-green-blue (RGB), infrared (IR), intensity, depth, time of flight cameras, etc.), microphones, wheel encoders, environment sensors (e.g., thermometer, hygrometer, light sensors, pressure sensors, etc.), etc. The sensor(s) 206 may include multiple instances of each of these or other types of sensors. For instance, the radar sensors may include individual radar sensors located at the corners, front, back, sides, and/or top of the vehicle 202. As another example, the cameras may include multiple cameras disposed at various locations about the exterior and/or interior of the vehicle 202. The sensor(s) 206 may provide input to the vehicle computing device(s) 204 and/or to computing device(s) 214. The position associated with a simulated sensor, as discussed herein, may correspond with a position and/or point of origination of a field of view of a sensor (e.g., a focal point) relative the vehicle 202 and/or a direction of motion of the vehicle 202.

The vehicle 202 may also include emitter(s) 208 for emitting light and/or sound, as described above. The emitter(s) 208 in this example may include interior audio and visual emitter(s) to communicate with passengers of the vehicle 202. By way of example and not limitation, interior emitter(s) may include speakers, lights, signs, display screens, touch screens, haptic emitter(s) (e.g., vibration and/or force feedback), mechanical actuators (e.g., seatbelt tensioners, seat positioners, headrest positioners, etc.), and the like. The emitter(s) 208 in this example may also include exterior emitter(s). By way of example and not limitation, the exterior emitter(s) in this example include lights to signal a direction of travel or other indicator of vehicle action (e.g., indicator lights, signs, light arrays, etc.), and one or more audio emitter(s) (e.g., speakers, speaker arrays, horns, etc.) to audibly communicate with pedestrians or other nearby vehicles, one or more of which comprising acoustic beam steering technology.

The vehicle 202 may also include network interface(s) 210 that enable communication between the vehicle 202 and one or more other local or remote computing device(s). For instance, the network interface(s) 210 may facilitate communication with other local computing device(s) on the vehicle 202 and/or the drive component(s) 212. Also, the network interface(s) 210 may additionally or alternatively allow the vehicle to communicate with other nearby computing device(s) (e.g., other nearby vehicles, traffic signals, etc.). The network interface(s) 210 may additionally or alternatively enable the vehicle 202 to communicate with computing device(s) 214. In some examples, computing device(s) 214 may comprise one or more nodes of a distributed computing system (e.g., a cloud computing architecture).

The network interface(s) 210 may include physical and/or logical interfaces for connecting the vehicle computing device(s) 204 to another computing device or a network, such as network(s) 216. For example, the network interface(s) 210 may enable Wi-Fi-based communication such as via frequencies defined by the IEEE 802.11 standards, short range wireless frequencies such as ultra-high frequency (UHF) (e.g., Bluetooth®, satellite), cellular communication (e.g., 2G, 3G, 4G, 4G LTE, 5G, etc.), or any suitable wired or wireless communications protocol that enables the respective computing device to interface with the other computing device(s). In some instances, the vehicle computing device(s) 204 and/or the sensor(s) 206 may send sensor data, via the network(s) 216, to the computing device(s) 214 at a particular frequency, after a lapse of a predetermined period of time, in near real-time, etc.

In some instances, the vehicle 202 may include one or more drive components 212. In some instances, the vehicle 202 may have a single drive component 212. In some instances, the drive component(s) 212 may include one or more sensors to detect conditions of the drive component(s) 212 and/or the surroundings of the vehicle 202. By way of example and not limitation, the sensor(s) of the drive component(s) 212 may include one or more wheel encoders (e.g., rotary encoders) to sense rotation of the wheels of the drive components, inertial sensors (e.g., inertial measurement units, accelerometers, gyroscopes, magnetometers, etc.) to measure orientation and acceleration of the drive component, cameras or other image sensors, ultrasonic sensors to acoustically detect objects in the surroundings of the drive component, lidar sensors, radar sensors, etc. Some sensors, such as the wheel encoders may be unique to the drive component(s) 212. In some cases, the sensor(s) on the drive component(s) 212 may overlap or supplement corresponding systems of the vehicle 202 (e.g., sensor(s) 206).

The drive component(s) 212 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive component(s) 212 may include a drive component controller which may receive and preprocess data from the sensor(s) and to control operation of the various vehicle systems. In some instances, the drive component controller may include one or more processors and memory communicatively coupled with the one or more processors. The memory may store one or more components to perform various functionalities of the drive component(s) 212. Furthermore, the drive component(s) 212 may also include one or more communication connection(s) that enable communication by the respective drive component with one or more other local or remote computing device(s).

The vehicle computing device(s) 204 may include processor(s) 218 and memory 220 communicatively coupled with the one or more processors 218. Memory 220 may represent memory 112. Computing device(s) 214 may also include processor(s) 222, and/or memory 224. The processor(s) 218 and/or 222 may be any suitable processor capable of executing instructions to process data and perform operations as described herein. By way of example and not limitation, the processor(s) 218 and/or 222 may comprise one or more central processing units (CPUs), graphics processing units (GPUs), tensor processing units (TPUs), integrated circuits (e.g., application-specific integrated circuits (ASICs)), gate arrays (e.g., field-programmable gate arrays (FPGAs)), and/or any other device or portion of a device that processes electronic data to transform that electronic data into other electronic data that may be stored in registers and/or memory.

Memory 220 and/or 224 may be examples of non-transitory computer-readable media that may store processor-executable instructions. The memory 220 and/or 224 may store an operating system and one or more software applications, instructions, programs, and/or data to implement the methods described herein and the functions attributed to the various systems. In various implementations, the memory may be implemented using any suitable memory technology, such as static random access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

In some instances, the memory 220 and/or memory 224 may store a localization component 226, perception component 228, planning component 230, log data 232, map data 234, system controller(s) 236, and/or machine-learned model 238—zero or more portions of any of which may be hardware, such as GPU(s), CPU(s), and/or other processing units. Perception component 228 may represent perception component 114, planning component 230 may represent planning component 116, system controller(s) 236 may represent controller(s) 132, and/or machine-learned model 238 may represent machine-learned model 134.

In at least one example, the localization component 226 may include hardware and/or software to receive data from the sensor(s) 206 to determine a position, velocity, and/or orientation of the vehicle 202 (e.g., one or more of an x-, y-, z-position, roll, pitch, or yaw). For example, the localization component 226 may include and/or request/receive map(s) of an environment, such as map data 234, and can continuously determine a location, velocity, and/or orientation of the autonomous vehicle within the map(s). In some instances, the localization component 226 may utilize SLAM (simultaneous localization and mapping), CLAMS (calibration, localization and mapping, simultaneously), relative SLAM, bundle adjustment, non-linear least squares optimization, and/or the like to receive image data, lidar data, radar data, IMU data, GPS data, wheel encoder data, and the like to accurately determine a location, pose, and/or velocity of the autonomous vehicle. In some examples, the localization component 226 may determine localization and/or mapping data comprising a pose graph (e.g., a sequence of position(s) and/or orientation(s) (i.e., pose(s)) of the vehicle 202 in space and/or time, factors identifying attributes of the relations therebetween, and/or trajectories of the vehicle for accomplishing those pose(s)), pose data, environment map including a detected static object and/or its distance from a pose of the vehicle 202, and/or the like In some instances, the localization component 226 may provide data to various components of the vehicle 202 to determine an initial position of an autonomous vehicle for generating a trajectory and/or for generating map data. In some examples, localization component 226 may provide, to the perception component 228 and/or planning component 230 a location and/or orientation of the vehicle 202 relative to the environment and/or sensor data associated therewith.

In some instances, perception component 228 may comprise a perception system and/or a prediction system implemented in hardware and/or software. The perception component 228 may detect object(s) in in an environment surrounding the vehicle 202 (e.g., identify that an object exists), classify the object(s) (e.g., determine an object type associated with a detected object), segment sensor data and/or other representations of the environment (e.g., identify a portion of the sensor data and/or representation of the environment as being associated with a detected object and/or an object type), determine characteristics associated with an object (e.g., a track identifying current, predicted, and/or previous position, heading, velocity, acceleration, and/or other state associated with an object), and/or the like. The perception component 228 may include a prediction component that predicts actions/states of dynamic components of the environment, such as moving objects, although the prediction component may be separate, as in the illustration. In some examples, the perception component 228 may determine a top-down representation of the environment that encodes the position(s), orientation(s), velocity (ies), acceleration(s), and/or other states of the objects and/or map data in the environment. For example, the top-down representation may be an image with additional data embedded therein, such as where various pixel channel values encode the perception data and/or map data discussed herein. Data determined by the perception component 228 is referred to as perception data.

The prediction component (of the perception component 228 or as an entirely separate component) may predict a future state of an object in the environment surrounding the vehicle 202. The future (predicted) state may indicate a predicted object position, orientation, velocity, acceleration, and/or other state (e.g., door state, turning state, intent state such as signaling turn) of a detected object. Data determined by the prediction component is referred to as prediction data and may be part of the perception data. In some examples, the prediction component may determine a top-down representation of a predicted future state of the environment. For example, the top-down representation may be an image with additional data embedded therein, such as where various channel pixel values encode the prediction data discussed herein.

The planning component 230 may receive a location and/or orientation of the vehicle 202 from the localization component 226 and/or perception data from the perception component 228 and may determine instructions for controlling operation of the vehicle 202 based at least in part on any of this data. In some examples, the memory 220 may further store map data 234 and this map data may be retrieved by the planning component 230 as part of generating environment state data. In some examples, determining the instructions may comprise determining the instructions based at least in part on a format associated with a system with which the instructions are associated (e.g., first instructions for controlling motion of the autonomous vehicle may be formatted in a first format of messages and/or signals (e.g., analog, digital, pneumatic, kinematic, such as may be generated by system controller(s) of the drive component(s) 212)) that the drive component(s) 212 may parse/cause to be carried out, second instructions for the emitter(s) 208 may be formatted according to a second format associated therewith). In some examples, where the planning component 230 may comprise hardware/software-in-a-loop in a simulation (e.g., for testing and/or training the planning component 230), the planning component 230 may generate instructions which may be used to control a simulated vehicle. These instructions may additionally or alternatively be used to control motion of a real-world version of the vehicle 202, e.g., in instances where the vehicle 202 runs the simulation runs on vehicle during operation.

In some examples, the log data 232 may comprise sensor data, perception data, planning data, map data, and/or scenario data collected/determined by the vehicle 202 (e.g., by the perception component 228), as well as any other message generated and or sent by the vehicle 202 during operation including, but not limited to, control messages, error messages, etc. In some examples, the vehicle 202 may transmit the log data 232 to the computing device(s) 214. In some examples, the computing device(s) 214 may determine scenario data from the log data by sampling a portion of the log data, such as a 5 second, 10 second, 20 second, 30 second, or any other duration of time from the log data. In some examples, these samples may be sampled at regular intervals or based at least in part on operations the vehicle 202 took or based on sampling a portion of log data before or after an event in the environment or an operation of the vehicle. For example, scenario data may be determined from a log data sample by determining a portion of the log data associated with a buffer time (e.g., 2 or 5 seconds, to give a non-limiting example) before the vehicle 202 entered an intersection, during the vehicle 202 transiting the intersection, and a buffer time after the vehicle 202 exited the intersection; a similar time window associated with an object cutting off the vehicle 202; a similar time window associated with the vehicle 202 parking or executing another specific maneuver; and/or the like.

In some examples, the map data 234 may comprise a two-dimensional or three-dimensional representation of the environment, characteristic(s) associated therewith, and/or embedding(s). A two-dimensional representation may include, for example, a top-down representation of the environment and a three-dimensional representation may comprise position, orientation, and/or geometric data (e.g., a polygon representation, a digital wire mesh representation). Either representation may comprise a label associated with a portion of the top-down representation indicating different characteristic(s) and/or feature(s) of the environment, such as the existence and/or classification of a static object (e.g., signage, mailboxes, plants, poles, buildings, and/or the like); areas of the environment relevant to the vehicle's operations (e.g., crosswalks, drivable surfaces/roadways, turning lanes, controlled intersections, uncontrolled intersections, sidewalks, passenger pickup/drop-off zones, and/or the like); conditional lighting data depending on the time of day/year and/or the existence and location of light sources; object characteristics (e.g., material, refraction coefficient, opacity, friction coefficient, elasticity, malleability); occlusion data indicating portion(s) of the environment that are occluded to one or more sensors of the vehicle 202; and/or the like. The occlusion data may further indicate occlusions to different classes of sensors, such as portion(s) of the environment occluded to visible light cameras but not to radar or lidar, for example. The two-dimensional representation and/or three-dimensional representation may have embeddings associated therewith that encode this data via the learned process discussed herein. For example, for a three-dimensional representation of the environment comprising a mesh, an embedding may be associated with a vertex of the mesh that encodes data associated with a face that may be generated based on one or more vertices associated with the face. For a two-dimensional representation of the environment an edge or other portion of the top-down representation may be associated with an embedding.

In some examples, memory 220 and/or memory 224 may store a machine-learned model 238, dynamic sampling component 240, simulation system 242, and/or validation component 244. These components may collectively and/or individually used to test and/or validate a component of the vehicle 202 or operation of the vehicle 202 in total. For example, a previous, new, or updated software and/or hardware component of the vehicle 202 may be tested to ensure that component or any changes thereto maintain or increase the safety and/or efficacy of operations of the vehicle 202. In some examples, the validation process discussed herein may ensure that a new or updated component will not degrade the safety and/or efficacy of operations of the vehicle 202 before updating the software and/or changing or adding hardware of the vehicle 202.

In some examples, the machine-learned model 238 may comprise a machine-learned model (e.g., a multi-layer perceptron (MLP), transformer-based machine-learned model, Kolmogorov-Arnold network (KAN), or the like) that determines a difficulty metric and/or an encoder that determines an embedding for scenario data in examples where clustering is used. During pre-training the machine-learned model 238 may further comprise a training decoder for training such an encoder. The machine-learned model 238 may additionally or alternatively comprise a clustering component. For example, the machine-learned model 238 may comprise a transformer-based machine-learned model or at least the encoder of a transformer-based machine-learned model. The machine-learned model 238 may additionally or alternatively comprise an aggregation layer that may follow the encoder that may concatenate multiple embeddings output by the encoder to determine the embedding for scenario data (as discussed herein) and/or the aggregation layer may comprise another ML model, such as a multi-layer perceptron (MLP), convolutional neural network (CNN), transformer, or the like. For example, the encoder(s) and decoder(s) discussed herein may form a transformer. For example, the encoder(s) and/or decoder(s) may have an architecture similar to visual transformer(s) (ViT(s)), such as a bidirectional encoder from image transformers (BEIT), visual bidirectional encoder from transformers (VisualBERT), image generative pre-trained transformer (Image GPT), data-efficient image transformers (DeiT), deeper vision transformer (DeepViT), convolutional vision transformer (CvT), detection transformer (DETR), Miti-DETR, or the like; and/or general or natural language processing transformers, such as BERT, ROBERTa, XLNet, GPT, GPT-2, GPT-3, or the like. Additionally or alternatively, the machine-learned model 238 may comprise one or more neural network architectures, such as VQGAN, which combines an autoregressive transformer with convolutional network components (or any other generative adversarial network (GAN), CLIP (which can be used to enhance sensor data learning with natural language supervision), or VQGAN and CLIP used together.

In some examples, the machine-learned model for determining the difficulty metric and/or the encoder may be pre-trained at computing device(s) 214 based at least in part on initial training data that is part of the log data 232. During pre-training of the encoder, the machine-learned model 238 may comprise at least an encoder and a training decoder for the purposes of reconstruction training. In such an example, the encoder may use scenario data to generate an embedding (or set of embeddings that are concatenated by or projected into a single embedding by the aggregation layers in an example where the encoder generates multiple embeddings) and the training decoder may be trained to reconstruct the original scenario data input into the encoder. During pre-training of the encoder, a training decoder may be appended to the encoder to complete the transformer architecture. This training decoder may receive an embedding generated by the encoder and, during this pre-training stage, this decoder is trained to estimate a reproduction or reconstruction of the original data that was provided to the encoder.

For example, a training decoder may determine an estimate of the input data using the embedding generated by the encoder (and/or the aggregation layer). The estimated input may be the training decoder's attempt to reconstruct the original data input to the encoder. As discussed herein, the difference between the estimate output by the training decoder and the original data input to the encoder may be used to determine, by a loss function (e.g., L1 loss, L2 loss, Huber loss, Cauchy loss, squared of the mean-squared error loss), a reconstruction loss that may be backpropagated through the training decoder, aggregation layer (if there is one), and/or the encoder using gradient descent. More simply, one or more parameters of any one or more of the training decoder, aggregation layer, and/or the encoder may be altered to reduce the loss. For example, such a parameter may comprise a weight, bias, or other parameter of a portion of the respective component. This process may be repeated for multiple instances of input data. Note that this process requires no extra ground truth data—the input data serves as the ground truth data, different from typical training arrangements. In some examples, the reconstruction stage or pre-training may comprise masking a portion of the input data, such as by filling a portion of the input with nonce data (e.g., 0, removing a portion of the input entirely), which may result in training the training decoder to reconstruct the entire input data, including the masked portion. In some examples, the percentage of the input data that is masked may start at zero or a small percentage and may progressively increase per batch of training data or once the average reconstruction loss per batch is below a threshold loss.

This training functionally results in training the encoder to generate an embedding that is located within an embedding space that differentiates the input scenario data from other scenario data. An embedding may include a vector or tensor representation of the input data in a high-dimensional space called an embedding space. Note that this embedding space may be high-dimensional compared to two- or three-dimensions (e.g., hundreds of dimensions or thousands of dimensions), but may have less or even far less dimensions than the input data, which may number in the thousands or millions of dimensions. With training, an encoder differentiates between data by locating embeddings at different locations in the embedding space to signify their relative similarities, differences, attributes, etc.

In some examples, the techniques may comprise appending a difficulty metric determined by another machine-learned model for first scenario data to the embedding determined by the encoder for the first scenario data. In such an example, the difficulty metric may be scaled (i.e., multiplied by a constant) to increase the effect the difficulty metric has on clustering the resultant vector (i.e., the embedding combined with the difficulty metric). Scaling the difficulty metric may functionally result in increasing the number of bits or values of the resultant vector that indicate the difficulty metric. For example, the output of the encoder may have n dimensions and the scaled difficulty metric may be a vector of p dimensions, such that the resulting combined vector has n+p dimensions. Additionally or alternatively, as discussed herein, the difficulty metric may comprise multiple difficulty metrics, each of which may have different values associated therewith. Accordingly, the original difficulty metric may be a vector of a first dimension indicating multiple difficulty metrics and the scaled difficulty metric may be a vector of a second dimension that is equal to or greater than the first dimension, depending on the constant(s) by which the difficulty metric(s) are scaled. Note that the difficulty metric(s) may be scaled by the same or different constants.

In an example where the encoder generates multiple embeddings (e.g., one embedding per portion of scenario data, rather than one embedding for the entire scenario data), an aggregation layer can force the projections of the input data to the embedding space to a smaller portion of the embedding space and/or project the embeddings into a single embedding of the same embedding space of the multiple embeddings or a different embedding space associated with the final embeddings. In a simplest example, the aggregation layer may concatenate the embeddings to form the embedding representing the input scenario data. In an additional or alternate example, the aggregation layer may receive multiple embeddings from the encoder, concatenated or not, and determine an embedding based at least in part on one or more MLP layers, KAN layers, a convolutional neural network (CNN), or a transformer that compose at least part of the aggregation layer to generate the embedding. The embedding may be a consistently sized embedding that aggregates the sub-embeddings that the embedding represents. Note that the embedding may exist in the same embedding space as the embedding space into which embeddings generated by the encoders are projected or it may be a different embedding space.

After pre-training is complete, the training decoder may be disassociated with the encoder, such as by removing the training decoder completely, by suppressing provision to the training decoder of the embedding(s) generated by the encoder, or the like. Additionally or alternatively, in examples where the encoder generates multiple embeddings for a single set of scenario data, the encoder may further comprise an aggregation layer to determine the embedding for scenario data based at least in part on two or more sub-embeddings generated by the encoder.

In some examples, the pre-training may further comprise training a machine-learned model (e.g., a MLP, KAN, neural network, a transformer) to generate a difficulty metric using first scenario data or the embedding for the first scenario data generated by the encoder. Training such a machine-learned model may comprise providing, as input to the machine-learned model, scenario data or an embedding thereof and generating, by the machine-learned model, a likelihood (e.g., a confidence or posterior probability) that an event would occur if the scenario was simulated and/or an estimated run time (e.g., time it would take to simulate at a particular processor speed and/or number of available processor cores and/or threads) and/or estimated computational resources (e.g., an amount of memory, an amount of threads) to simulate the scenario indicated by the scenario data. In some examples, the machine-learned model may comprise multiple heads for generating multiple difficulty metrics, such as an output head predicting the likelihood of a simulated vehicle will contact an object, an output head predicting the likelihood operation of the simulated vehicle will result in a comfort event, an output head predicting the likelihood operation of the simulated vehicle will result in a degraded operation event, and/or an output head predicting an estimated run time, etc. Regardless, a simulation of the scenario data may be run and a loss may be determined based at least in part on a difference between what occurred during the simulation of the scenario (e.g., whether the simulated vehicle contacted an object, whether a comfort event occurred, whether a degraded operation occurred, how long the simulation took) and the prediction output by the machine-learned model. This may comprise determining multiple losses if multiple output heads are present (e.g., determining a loss for each output). These losses may be backpropagated through the pertinent portions of the machine-learned model (e.g., the input node(s), any intermediate layer(s), and the output head associated with the particular loss) and one or more parameters of the machine-learned model may be altered to reduce the loss, e.g., according to a gradient descent algorithm. These parameter(s) may include, for example, a weight, bias, activation function parameter, and/or the like.

Additionally or alternatively, once the machine-learned model and/or encoder have been pre-trained, the machine-learned model and/or encoder may be transmitted, as machine-learned model 238, to the vehicle 202 for operation on the vehicle 202. In some examples, before transmission the machine-learned model and/or the encoder may be distilled via knowledge distillation techniques. Additionally or alternatively, the cluster(s) and/or performance metric(s) determined for different clusters, characteristics of scenario data, and/or the like (as discussed further herein), may also be transmitted to the vehicle 202 for use by the vehicle to control operations of the vehicle 202, as discussed further here.

The machine-learned model 238 stored on the remote computing device(s) 214 may further comprise a clustering component for determining the clusters discussed herein. The clustering component may use the embeddings generated by the encoder (and/or aggregation layer) for different scenarios (i.e., different scenario data) to cluster the embeddings into different clusters, i.e., determine a cluster with which to associate up to each embedding. Such clustering may, functionally, determine a cluster that indicates sets of scenario data (i.e., segments of log data) that are associated with similar scenarios and determine a different cluster for sets of log data that do not share such similarities. In some examples, the clustering may comprise k-means, k-medians, agglomerative clustering, mean shift clustering, density-based spatial clustering (DBSCAN), t-distributed stochastic neighbor embedding (t-SNE), or the like to determine k number of clusters of the embeddings, where k is a positive integer. In some examples, k may be determined based at least in part on a previous batch of simulations used to test a component and may change depending on the particular component being tested. Additionally or alternatively, k may be a trained parameter determined as part of a machine-learning training or determined based at least in part on a target number of simulations (e.g., k=10% of the target number of simulations).

The dynamic sampling component 240 may randomly sample scenario data from the clusters as log data to be simulated by the simulation system 242. The number of samples sampled from the clusters may be determined according to the techniques discussed herein. In some examples, the dynamic sampling component 240 may sample from every cluster, randomly determine which cluster to sample from, or may additionally or alternatively iteratively sample from the clusters according to a pattern. In at least one example, the dynamic sampling component 240 may default to uniform sampling across the clusters, such as by sampling a minimum number from each cluster, which, for smaller cluster(s), may end up sampling the entire cluster. Additionally or alternatively, the dynamic sampling component 240 may additionally or alternatively sample a percentage or a lower or higher minimum number for a percentage of the clusters, according to the techniques discussed herein. For example, uniform sampling using a first minimum number may be used for 80% of the clusters, 5% of the clusters may be sampled using a percentage, 10% of the clusters may be sampled using a minimum number greater than the first minimum number, and 5% of the clusters may be sampled using a minimum number less than the first minimum number. These are only given as examples however, as any combination of uniform, percentage, or other sampling techniques may be used. In another example, the sampling rate may increase proportionally to an average difficulty metric of the subset of scenario data associated with a cluster. Additionally or alternatively, before sampling, the top n % of scenarios ranked by difficulty metric may be simulated (without replacement) before sampling to ensure that a difficult scenario is simulated even if it was clustered into a cluster with scenarios that are associated with low difficulty metrics.

The simulation system 242 may operate on the vehicle 202 and/or on the computing device(s) 214 (although FIG. 2 depicts the simulation system 242 as operating on the computing device(s) 214). If the simulation system 242 is operating on the vehicle, the simulation system 242 may provide alternate prediction(s) about the maneuver and/or path that an object may take. These alternate prediction(s) may be provided as input to the planning component 230. The simulation system 242 may run parallel to the perception component 228 and/or the perception component 228 may be part of the simulation system 242 and/or provide perception data to the simulation system 242.

The simulation system 242 may determine a simulation of the environment and/or the vehicle 202 based at least in part on log data/scenario data sampled from a cluster by the dynamic sampling component 240. In some examples, the simulation may be based at least in part on providing a set of log data as input to one or more components of the autonomous vehicle. For example, the scenario data may comprise sensor data, perception data, localization data, and/or planning data. Depending on the component being tested, such as whether the component is part of the localization component 226, the perception component 228, the planning component 230, the system controller(s) 236, or a hardware change to these or any of the other components, the simulation may be based at least in part on providing the sensor data, perception data, localization data, and/or planning data as input to any one or more of these components. In many examples, the planning data may be left out in order to use the planning data as part of testing operation of one or more components of the vehicle 202 and/or overall behavior of the vehicle 202.

The simulation may additionally or alternatively comprise a representation of a position, orientation, movement, and/or quality of portions of the environment and/or the vehicle 202. The simulated environment may comprise an object, such as another vehicle, a pedestrian, vegetation, a building, signage, and/or the like. Simulations can be used to validate software executed on the vehicle 202 and/or hardware of the vehicle 202 and to determine performance metrics (such as safety and/or efficacy metrics) to ensure that the software and/or hardware is able to safely control such vehicles in various simulated scenarios. In additional or alternative examples, simulations can be used to learn about the constraints of autonomous vehicles that use the autonomous controller.

Simulations can be used to understand the operational space of an autonomous vehicle (e.g., an envelope in which the autonomous controller effectively controls the autonomous vehicle) in view of surface conditions, ambient noise, faulty components, etc. Simulations can also be useful for generating feedback for improving operations and designs of autonomous vehicles. For instance, in some examples, simulations can be useful for determining an amount of redundancy that is required in an autonomous controller, how to modify a behavior of the autonomous controller based on what is learned through simulations, or whether the autonomous controller is ready to be deployed.

In some examples, the simulation may be a two or three-dimensional representation of the scenario. For example, the three-dimensional representation may comprise position, orientation, geometric data (e.g., a polygon representation, a digital wire mesh representation) and/or movement data associated with one or more objects of the environment and/or may include material, lighting, and/or lighting data, although in other examples this data may be left out. In some examples, a simulated sensor may determine simulated sensor data based at least in part on the simulation generated by the simulation system 242. For example, U.S. Pat. No. 11,928,399, filed Sep. 24, 2019 and incorporated by reference herein for all purposes, discusses this in more detail. In an additional or alternate example, the simulation may itself comprise simulated sensor data and/or simulated perception data.

In an example where the perception component 228 and/or planning component 230 is/are being tested, the perception component 228 (e.g., a copy thereof, which may comprise software and/or hardware, which may include hardware-in-the-loop simulation) may receive the sensor data from the set of log data/scenario data (or simulated sensor data) and may output perception data to the planning component 230 (e.g., a copy thereof, which may comprise software and/or hardware, which may include hardware-in-the-loop simulation). Additionally or alternatively planning component 230 may receive simulated perception data from the simulation system 242 or perception data from the set of log data determined by the dynamic sampling component 240. Additionally or alternatively, the localization component 226 (e.g., a copy thereof, which may comprise software and/or hardware, which may include hardware-in-the-loop simulation) may receive sensor data from the set of log data and may output localization data to the planning component 230.

The planning component 230 may generate a trajectory for controlling vehicle 202, which may be used by the simulation system 242 to control a simulation of the vehicle 202 in addition to or instead of sending instructions to the drive component(s) 212 to implement the trajectory. In some examples, the trajectory may additionally or alternatively be provided to the system controller(s) 236 and hardware-in-the loop or an output of the system controller(s) 236 may be used to control a simulation of the vehicle 202. Accordingly, this trajectory and/or instructions determined by system controller(s) 236 may control a simulated position, orientation, velocity, acceleration, state, and/or turn rate of a simulated vehicle in a simulated environment generated by the simulation system 242.

In some examples, the simulation system 242 or the validation component 244 may additionally or alternatively determine one or more performance metrics based at least in part on the simulation or an outcome of the simulation. The results may include data such as the minimum distance from the simulated representation of the vehicle 202 to any simulated object over the course of the simulation, a velocity of the autonomous vehicle over the course of the simulation, and/or a number of contacts with an object, failures to detect an object, pauses, stops, alterations or ending of a mission or route, idling, failing to determine an operation to control the vehicle, or the like. In some examples, an average performance metric may be determined for all the simulations executed for samples from all the clusters (i.e., an overall performance metric), for simulations conducted for scenario data sampled from a particular cluster, and/or for simulations conducted for a same attribute of scenario data (e.g., a same real-world location, a same vehicle maneuver, a same object behavior). Moreover, although the performance metric is discussed herein as a single performance metric, it is understood that multiple average performance metrics may be determined (e.g., multiple overall performance metrics, multiple average performance metrics per cluster, multiple average performance metrics per attribute). For example, the different performance metrics may comprise a rate at which simulation resulted in contact with an object, failing to detect an object, pausing, stopping, altering or ending a mission or route, idling, failing to determine an operation to control the vehicle, or the like. The performance metric may be indicated as a rate, such as how frequently such an adverse event occurs per 1,000 miles simulated and/or as a difference of the performance metric in comparison to a baseline performance metric, such as a prior version of the component being validated.

In some examples, the validation component 244 may store a ruleset and may determine whether the component being tested (i.e., a target component) passed or failed a scenario based at least in part on the ruleset. Additionally or alternatively, the ruleset may define threshold performance metric(s) for indicating whether the target component is validated for use by the vehicle 202 or not. In some examples, the simulation system 242 may record a version of the target component in association with a scenario identifier and/or an indication of whether the target component passed or failed. In an additional or alternate example, the simulation system 242 may determine a non-binary indication associated with performance of the target component (e.g., a score in addition to or instead of a pass/fail indication). The non-binary indication may be based at least in part on a set of weights associated with the ruleset. In some examples, the ruleset may be part of or replaced by an event detection system (U.S. Pat. No. 11,697,412, filed Nov. 13, 2019, the entirety of which is incorporated by reference herein for all purposes) and/or a collision monitoring system (U.S. Pat. No. 11,590,969, filed Dec. 4, 2019, the entirety of which is incorporated by reference herein for all purposes).

Regardless, any of the results, events, rulesets, etc. discussed above may be used to determine the one or more performance metrics associated with a target component or the vehicle 202 overall performance. In some examples, the validation component 244 may additionally or alternatively determine a confidence score (e.g., a confidence interval) associated with a performance metric. In at least one example, one of the metrics may be a number of contacts or disengagements per thousand miles, a probability of disengagement or contact, or the like.

The memory 220 and/or 224 may additionally or alternatively store a mapping system, a planning system, a ride management system, simulation component, a logging component that aggregates the log data 232 from output(s) of respective components of the vehicle 202, etc.

As described herein, the localization component 226, the perception component 228, the planning component 230, the machine-learned model 238, simulation system 242, and/or other components of the system 200 may comprise one or more ML models. For example, localization component 226, the perception component 228, the planning component 230, the machine-learned model 238 (and components thereof), and/or simulation system 242, may each comprise different ML model pipelines. In some examples, an ML model may comprise a neural network. An exemplary neural network is an algorithm that passes input data through a series of connected layers to produce an output. Each layer in a neural network can also comprise another neural network, or can comprise any number of layers (whether convolutional or not). As can be understood in the context of this disclosure, a neural network can utilize machine-learning, which can refer to a broad class of such algorithms in which an output is generated based on learned parameters.

Although discussed in the context of neural networks, any type of machine-learning can be used consistent with this disclosure. For example, machine-learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet-50, ResNet-101, VGG, DenseNet, PointNet, Xception, ConvNeXt, and the like; visual transformer(s) (ViT(s)), such as a bidirectional encoder from image transformers (BEIT), visual bidirectional encoder from transformers (VisualBERT), image generative pre-trained transformer (Image GPT), data-efficient image transformers (DeiT), deeper vision transformer (DeepViT), convolutional vision transformer (CvT), detection transformer (DETR), Miti-DETR, or the like; and/or general or natural language processing transformers, such as BERT, GPT, GPT-2, GPT-3, or the like. In some examples, the ML model discussed herein may comprise PointPillars, SECOND, top-down feature layers (e.g., see U.S. Pat. No. 10,649,459, filed Apr. 26, 2018, which is incorporated by reference in its entirety herein for all purposes), and/or VoxelNet. Architecture latency optimizations may include MobilenetV2, Shufflenet, Channelnet, Peleenet, and/or the like. The ML model may comprise a residual block such as Pixor, in some examples.

Memory 220 may additionally or alternatively store one or more system controller(s) 236 (which may be a portion of the drive component(s)), which may be configured to control steering, propulsion, braking, safety, emitters, communication, and other systems of the vehicle 202. These system controller(s) 236 may communicate with and/or control corresponding systems of the drive component(s) 212 and/or other components of the vehicle 202. For example, the planning component 230 may generate instructions based at least in part on perception data generated by the perception component 228 and/or simulated perception data and transmit the instructions to the system controller(s), which may control operation of the vehicle 202 based at least in part on the instructions.

It should be noted that while FIG. 2 is illustrated as a distributed system, in alternative examples, components of the vehicle 202 may be associated with the computing device(s) 214 and/or components of the computing device(s) 214 may be associated with the vehicle 202. That is, the vehicle 202 may perform one or more of the functions associated with the computing device(s) 214, and vice versa.

### Example Difficulty Metric Generation Architecture

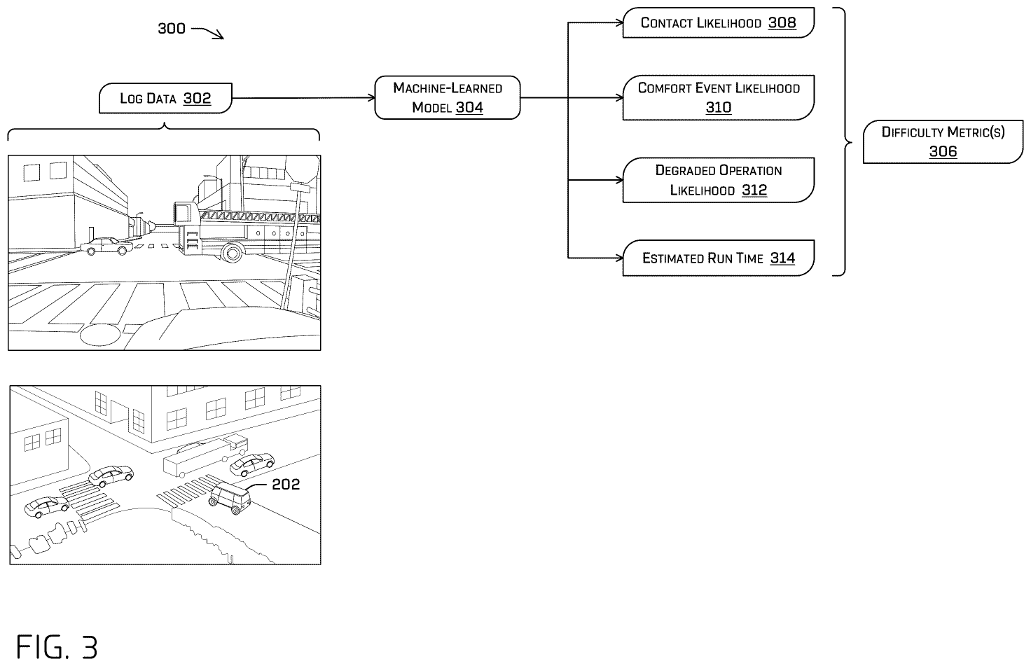

FIG. 3 illustrates a block diagram of an example architecture 300 for generating a difficulty metric for a first scenario. In some examples, example architecture 300 may be stored and executed at computing device(s) 214 or vehicle 202. The example architecture 300 may comprise a single machine-learned model, a single machine-learned model with multiple output heads, and/or multiple machine-learned model that determine respective outputs.

The example architecture 300 may comprise a machine-learned model 304 that receives log data 302 or an embedding determined by an encoder based at least in part on the log data 302. Note that the log data 302 is also referred to as scenario data herein. The example log data 302 comprises at least a depicted image and may additionally or alternatively comprise three-dimensional data, such as lidar data, radar data, and/or the like. The machine-learned model 304 may comprise any suitable machine-learned model, such as a MLP, KAN, transformer-based machine-learned model, and/or the like. In an example where the machine-learned model 304 receives an embedding of the log data 302, the machine-learned model 304 may comprise a transformer decoder, a MLP, KAN, neural network, or the like.

In some examples, the machine-learned model 304 may comprise one or more output heads, each of which may determine a different difficulty metric, or the machine-learned model may comprise multiple machine-learned models, each of which determine a particular difficulty metric or that may comprise multiple output heads for determining multiple difficulty metrics. These outputs are collectively referred to as the difficulty metric(s) 306, although it should be understood that the discussion of a difficulty metric may include one or more difficulty metrics. Regardless, the machine-learned model 304 may determine a contact likelihood 308, a comfort event likelihood 310, a stuck event likelihood 312, and/or an estimated run time 314. In other words, the difficulty metric(s) may indicate a likelihood or binary indication that an adverse event will occur during simulation of a scenario.

For any of these difficulty metrics, the machine-learned model 304 may be trained to output a binary value (i.e., a 1 to indicate a prediction that a particular event will occur) or a confidence (e.g., a logit indicating a posterior probability that an event will occur) associated with simulating the log data 302. In some examples, the contact likelihood 308 may indicate a likelihood or a binary prediction that the vehicle will/won't contact an object during simulation of the log data 302. The comfort event likelihood 310 may indicate a likelihood or a binary prediction that the vehicle will/won't violate a comfort constraint. For example, the comfort constraint may comprise a threshold acceleration and/or threshold jerk, which may be defined as different lateral, longitudinal, and/or cumulative thresholds. The stuck event likelihood 312 may indicate a likelihood or a binary prediction that operation of the vehicle during simulation of the log data 302 will/won't result in the vehicle pausing, stopping, diverting, altering or ending a mission or route, idling, failing to determine an operation to control the vehicle, and/or determining to transmit a request for teleoperations assistance. Estimated run time 314 may comprise an indication of minutes that the simulation is estimated to take (e.g., at an assumed processor speed and/or number of threads or cores) and/or computational resources required to simulate the log data 302. In some examples, the techniques may comprise averaging or weighted averaging the contact likelihood 308, comfort event likelihood 310, and/or degraded operation likelihood 312 in an example where a total likelihood is desired. In an example where weighted averaging is used, the weight given to the contact likelihood 308 may exceed the weights given the comfort event likelihood 310 and the degraded operation likelihood 312.

In some examples, the results of simulating log data 302 may be used to further train machine-learned model 304. In some examples this further training may be conducted if the log data 302 has never been simulated or even if the log data 302 has been previously simulated but a component of the vehicle has been altered (e.g., a component has been added, removed, or altered, such as via software updating, hardware tuning or changes, etc.) since the log data 302 was last simulated. Regardless, the results of simulating log data 302 may comprise an indication of whether the simulated vehicle contacted an object, whether a comfort event occurred (e.g., the vehicle operated at any point such that an acceleration or jerk of the vehicle met or exceeded a threshold acceleration or threshold jerk), whether a degraded operation event occurred (e.g., the vehicle paused for longer than a threshold time, idled for longer than a threshold time, altered or ended a mission, transmitted a request for teleoperations assistance, failed to generate a command for controlling the vehicle), a time the simulation took, and/or the maximum computational resources required to run the simulation. Any of this data may be used as ground truth data for training or fine-tuning the machine-learned model 304.

Training or refining the machine-learned model 304 may comprise determining loss(es) based at least in part on a difference between the predicted difficulty metric and the respective result of the simulation and altering one or more parameters of the machine-learned model 304 to reduce the loss. In some examples, this training and/or refinement may occur in batches (e.g., after q number of simulations have been run, where q is a positive integer) or after a single simulation has occurred.

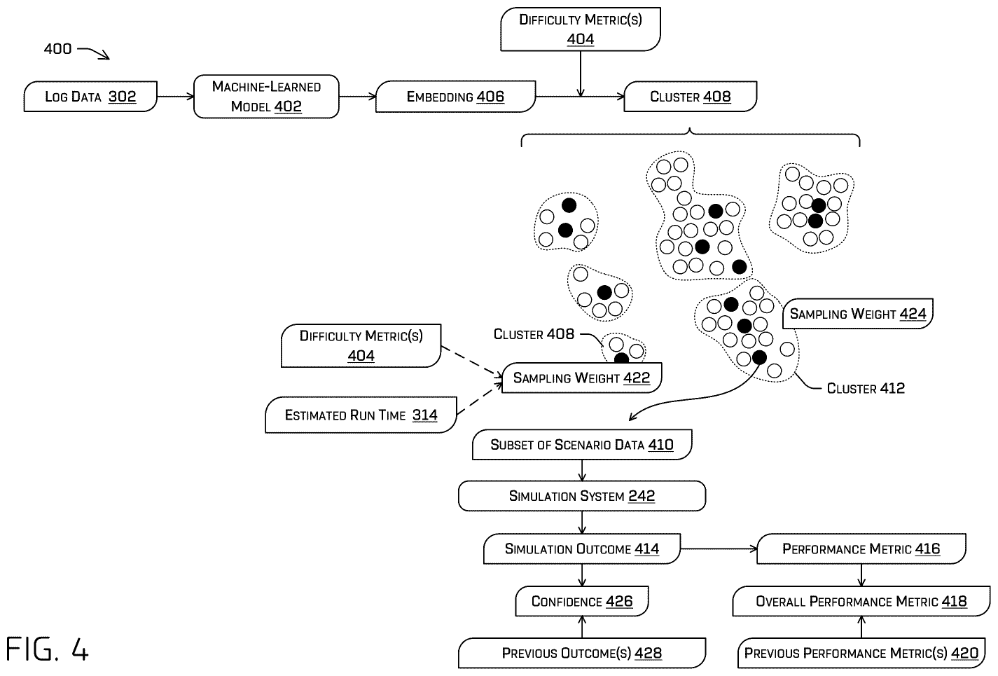

In some examples, the machine-learned model 304 may determine any or all of the difficulty metric(s) 306 for each instance of scenario data in a set of scenario data. In some examples, the techniques discussed herein may comprise ranking the instances of scenario data by average difficulty metric(s) or ranking the instances of scenario data for each of the likelihoods. In some examples, the techniques discussed herein may include determining the instances of scenario data to simulate purely based on determining the top n % of instances of scenario data in each difficulty metric ranked list or in the averaged difficulty metric list, although the percentage taken from each list need not be the same. The techniques may comprise determining to include these top n % of instances of scenario data in a subset of the scenario data for simulating, as discussed further regarding FIG. 4. Additionally or alternatively, the techniques may further comprise including additional instances of scenario data in the subset of scenario data for simulating based on sampling clusters determined according to the process discussed regarding FIG. 4. Additionally or alternatively, the techniques may comprise dispensing with determining the top n % of instances of scenario data and may purely use sampling the clusters as discussed regarding FIG. 4.

### Example Log Data Clustering, Sampling, and Simulation Process

FIG. 4 illustrates a block diagram of an example process 400 for using the difficulty metrics discussed herein to cluster and/or sample log data for simulation, while tracking the confidence in performance metrics determined for the simulations and adjusting an overall performance metric due to the reduced amount of log data used. In some examples, the machine-learned model 402 may comprise an encoder as discussed above regarding FIG. 2. Additionally or alternatively, the machine-learned model 402 may comprise the encoder and the machine-learned model 304. In such an example, the machine-learned model 402 may comprise a single backbone model where the encoder is a first output head that determines an embedding for an instance of scenario data and the machine-learned model 304 may comprise one or more layers and/or output head(s) to determine the difficulty metric(s) 306. Otherwise, the encoder may comprise a first backbone model and the machine-learned model 304 may comprise a second backbone model.

Regardless, the machine-learned model 402 may generate an embedding 406 for each instance of scenario data of a set of scenario data. For example, the set of scenario data may be log data 402, which may comprise different sets of log data, each of which may comprise an instance log data generated by the vehicle 202 over a defined period of time. In some examples, the log data may comprise sensor data, perception data, map data, and/or the like. More generally, scenario data may comprise log data and/or synthetic (computer and/or user-generated) log data comprising synthetic sensor data, perception data, map data, and/or the like. The discussion herein pertains to at least a first instance of log data but may be extended to additional instances of log data, up to all of the log data sets. The machine-learned model 402 or a preprocessing component may divide a set of log data into segments as instances of scenario data. For example, the machine-learned model 238 or the preprocessing component may divide the first set of log data into segments each associated with a 10 second, 15 second, 30 second, or any other period of time.

To give a practical example, if the first set of log data includes log data generated by the vehicle over 2 minutes and the segments are each associated with 15 seconds of log data, the clustering component may divide the first set of log data into 8 segments of 15 seconds each. In some examples, these samples may be sampled at regular intervals (as discussed above) or based at least in part on operations the vehicle took or based on sampling a portion of log data before or after an event in the environment or an operation of the vehicle. For example, scenario data may be determined from a log data sample by determining a portion of the log data associated with a buffer time (e.g., 2 or 5 seconds, to give a non-limiting example) before the vehicle entered an intersection, during the vehicle transiting the intersection, and a buffer time after the vehicle exited the intersection; a similar time window associated with an object cutting off the vehicle; a similar time window associated with the vehicle parking or executing another specific maneuver; and/or the like.

In some examples, these segments may be determined based at least in part on additional log data, such as sensor data and/or perception data used by a machine-learned model to determine the segment start/end times and/or human labelling, to avoid segmenting log data in the middle of a salient event, such as starting or ending a segment in the middle of executing a turn, proceeding through a junction, or the like. In some examples, the segment may be lengthened or shortened to incorporate or include such an event based at least in part on the log data and/or human labelling. This lengthening or shortening may be accomplished by a set of rules where the segment may be lengthened or shortened if log data indicates that an event identified in the rules is occurring at a time associated with a preliminary end to the segment. In some examples, the rules may further identify whether to lengthen or shorten the segment based on an event type, such as may be indicated by control data (e.g., whether control signals sent to the vehicle drive components indicate a turn was being executed or that the vehicle was parking), perception data, sensor data, and/or the like. Moreover, the determination to lengthen or shorten may be based at least in part on whether an additional salient event occurs before or after the event and/or how much time remains until the completion of the event compared to a total time of the event. For example, if three quarters of the total time to complete a turn has passed by the preliminary end of the segment, the segment may be lengthened until the vehicle completes the turn (and a subsequent segment may be shortened); whereas, if one quarter of the total time to complete a turn has passed by the preliminary end of the segment, the segment may be shortened to exclude executing the turn completely (and a subsequent segment may be lengthened to include executing the turn).

An encoder of the machine-learned model 402 may use first scenario data (i.e., an instance of scenario data and one part of the set of scenario data) to determine an embedding 406 for the first scenario data. The machine-learned model 402 or the machine-learned model 304 may additionally or alternatively determine difficulty metric(s) 404 for the first scenario data. For example, the machine-learned model 402 or the machine-learned model 304 may determine the difficulty metric(s) 404 using the first scenario data as input or using the embedding 406 as input. In an example where the encoder determines sub-embeddings for each portion of a segment of scenario data (e.g., a first embedding for a first image or for all images, a second embedding for lidar data, etc.), such sub-embeddings may be concatenated together and/or projected, by an aggregation layer, into an embedding space as the embedding 406 of the scenario data. The encoder may determine such an embedding for up to each instance of scenario data of the set of scenario data.

The difficulty metric(s) 404 may be used to augment clustering of the embedding 406, to weight the embedding 406, and/or to weight a cluster with which the embedding 406 is associated according to the clustering algorithm. For example, the difficulty metric(s) 404 may be scaled (optionally to increase the impact thereof on clustering) and concatenated to the embedding 406 or the difficulty metric(s) 404 and the embedding 406 may be used as input to a machine-learned model to determine an augmented embedding for use in clustering.

Regardless of whether the difficulty metric(s) 404 are used to generate an augmented embedding for the instances of scenario data, embeddings (augmented or not) may be generated for up to each instance of scenario data. These embeddings may be used by a clustering component of the machine-learned model 238 to determine k number of clusters into which to classify the embeddings generated for the set of scenario data. In some examples, the clustering may comprise k-means, k-medians, agglomerative clustering, mean shift clustering, DBSCAN, t-SNE, or the like. As a result of the clustering operations, each embedding may be associated with a cluster. Association of embeddings with a same cluster may indicate that the subsets of scenario data associated with that cluster are similar and are sufficiently different from other subsets of scenario to not be included in a different cluster. FIG. 4 depicts the example embeddings as circles and clusters as dotted lines surrounding the embeddings. For example, embedding 406 may be clustered into cluster 408 whereas another embedding associated with a different instance of scenario data may be clustered into cluster 412.

The dynamic sampling component 240 may randomly and/or uniformly sample from the clusters of embeddings to determine instances of scenario data to be simulated by the simulation system 242. For example, the dynamic sampling component 240 may, as a result of the random sampling from cluster 412, select, as a part of the subset of set of log data 410, the embedding associated with the scenario data for which embedding 406 was determined. The random sampling may exclude any previously sampled log data (i.e., the sampling may occur without replacement). In some examples, the dynamic sampling component 240 may randomly determine which cluster to sample from or may additionally or alternatively iteratively sample from the clusters according to a pattern. According to the examples discussed herein, there may be a requirement to run a minimum number of simulations, in which case the dynamic sampling component 240 may sample at least a minimum number of samples from each cluster. In some examples, once this minimum number of samples has been sampled from each cluster, the dynamic sampling component 240 may continue to sample according to a same pattern or may randomly select a cluster to sample from. Additionally or alternatively, after the minimum number of samples from each cluster has been sampled from each cluster, the dynamic sampling component 240 may determine the cluster to sample from based at least in part on determining, for each cluster, an average difference in variance (e.g., of the simulation outcome and/or of characteristic(s) of the log data used for simulation) or confidence score that resulted from the last p number of samples sampled from a cluster and sampling from the cluster associated with a greatest average difference in variance or confidence score, where p is a positive integer.

In at least one example, the dynamic sampling component 240 may default to uniform sampling across the clusters, such as by sampling a minimum number from each cluster, which, for smaller cluster(s), may end up sampling the entire cluster. Additionally or alternatively, the dynamic sampling component 240 may sample a percentage or a lower or higher minimum number for a percentage of the clusters, according to the techniques discussed herein. For example, uniform sampling using a first minimum number may be used for 80% of the clusters, 5% of the clusters may be sampled using a percentage, 10% of the clusters may be sampled using a minimum number greater than the first minimum number, and 5% of the clusters may be sampled using a minimum number less than the first minimum number. These are only given as examples however, as any combination of uniform, percentage, or other sampling techniques may be used.

In some examples, the dynamic sampling component 240 may additionally or alternatively determine a rate at which to sample a cluster based at least in part on a sampling weight associated with a cluster. The techniques may comprise determining a sampling weight associated with a cluster based at least in part on the difficulty metric(s) 404 of the instances of scenario data within the cluster. For example, the weight (and accordingly the sampling rate) may increase proportionally or exponentially to an increase in the contact likelihood, comfort event likelihood, and/or degraded operation likelihood. In some examples, the weight may be determined based at least in part on an average or weighted average of these likelihoods. Additionally or alternatively, the sampling weight or a separate sampling weight may be determined based on an estimated run time where such a weight may increase in likelihood proportionally to a decrease in the estimated run time 314. For example, the sampling weight 422 associated with cluster 408 may be less than a sampling weight 424 associated with cluster 412. This may result in the dynamic sampling component selecting more instances of scenario data from cluster 412. This may be advantageous because some clusters, like cluster 412, may be large enough that they may not have a large percentage of samples selected therefrom and, in a case where the average difficulty metric(s) associated with such a cluster is higher than the average difficulty metric(s) associated with other clusters, this ensures that cluster 412 ends up being more deeply sampled.

In some examples, the estimated run time 314 may serve as a filter instead of a weight and may be used for individual instances of scenario data instead of or in addition to an average for a whole cluster. For example, once uniform sampling or a certain amount of progress in the uniform sampling of the clusters has been completed, the clusters may be filtered to exclude instances of scenario data associated with estimated run times that meet or exceed a threshold time duration. Additionally or alternatively, once uniform sampling of the clusters has been completed or after a certain amount of progress in the uniform sampling has been completed, the estimated run time may be additionally used as a factor for determining the sampling weights associated with the clusters.

In some examples, the dynamic sampling component 240 may additionally or alternatively determine a rate at which to sample a cluster based at least in part on performance metric(s) of the log data associated with that cluster. For example, the performance metric(s) may be any of the performance metrics discussed at operation 518 associated with occurrence(s) in the log data that was received from the vehicle. In some examples, the performance metric(s) may additionally or alternatively indicate a violation of a constraint and/or a rate at which a constraint was violated (e.g., per mile driven/per time the vehicle was operated) for the log data associated with the cluster. For example, a cluster of log data associated with original log data or simulated log data for which an average time-to-contact, a minimum distance to an object, or a post-encroachment time is less than a respective threshold (i.e., a violation of a constraint that meets or exceeds a threshold number or rate of violations) may be used to increase the sampling rate. Determining the rate at which the sample the cluster may comprise increasing a percentage of the scenario data sampled from the cluster commensurate with a rate at which a constraint was violated (e.g., the percentage increases as the rate a constraint was violated increases). In some examples, this rate of sampling may be determined before simulation. In at least some examples, such rates may be determined based at least in part on an overall safety determination of the vehicle based on anticipated scenarios or otherwise.

Additionally or alternatively, the rate at which a cluster is sampled may be modified as log data is sampled from the cluster and simulated. For example, the sampling rate may be decreased if the constraint violation rate determined as a result of at least q number of simulations based on log data from the cluster is reduced compared to an original constraint violation rate associated with the scenario data, as determined before simulation; and/or the sampling rate may be increased if the constraint violation rate determined as a result of at least q number of simulations based on scenario data from the cluster is increased compared to the original constraint violation rate associated with the scenario data, where q is a positive integer. Additionally or alternatively, the sampling rate may be adjusted regardless of the original constraint violation rate associated with the scenario data, such as by increasing sampling of a cluster associated with a constraint violation number or rate above an upper threshold, and/or decreasing sampling associated with a constraint violation number or rate below a lower threshold, where the upper threshold is greater than the lower threshold.

Additionally or alternatively to using constraint violation rates, raw performance metric(s) may additionally or alternatively be used for determining the sampling rate before simulation and/or modifying the sampling rate after q simulations have been simulated, where q is a positive integer. Additionally or alternatively, a characteristic of the scenario data that is associated with a constraint violation number or rate that meets or exceeds a threshold violation number or rate may be used to increase a sampling rate of any scenario data associated with that characteristic. For example, the characteristic may include a real-world location, a configuration of object(s) relative to the vehicle, a vehicle maneuver (e.g., slowly pulling forward, accelerating, decelerating around a turn), and/or the like. Note that a characteristic may include a combination of such characteristics.

Regardless, the dynamic sampling component 240 may provide as input to the simulation system 242 the instances of scenario data (collectively a subset of the original set of scenario data) determined as a result of sampling the embeddings from the clusters. In the depicted example, an instance of scenario data sampled from cluster 412 has been determined by the dynamic sampling component to be included in the subset of scenario data 410 for simulation. Currently or previously sampled embeddings are depicted with dark fill whereas un-sampled embeddings are depicted without fill.

The simulation system 242 may provide an instance of scenario data in the subset of scenario data 410 to respective components of the vehicle 202 as part of the simulation and may generate a simulation outcome 414 as a result of the simulation. In some examples, the simulation outcome 414 may comprise simulation scenario data associated with simulated operation of the vehicle. For example, the simulation system 242 may record vehicle and/or object position, heading, velocity, acceleration, jerk, and/or the like at each frame or every n number of frames of the simulation, where n is a positive integer. Additionally or alternatively, the simulation outcome 414 may comprise a performance metric 416 indicating number of event(s) that occurred, such as a number of times simulating operation of the vehicle using the target component resulted in the vehicle contacting an object; coming within a threshold distance of an object; failing to detect an object; pausing, stopping, altering or ending a mission or route; idling; failing to determine an operation to control the vehicle; violating a constraint; and/or the like. A constraint may indicate nominal driving behavior that satisfies the constraint by indicating a threshold and an indication of whether satisfying the threshold/operating nominally is defined by meeting or exceeding the threshold or being below the threshold. For example, a jerk constraint may indicate that the vehicle performed nominally/satisfied the jerk constraint by operating such that a maximum jerk exerted by the vehicle is below the jerk threshold indicated by the jerk constraint. Whereas, for a gap time constraint, the gap time constraint may indicate that the vehicle performed nominally/satisfied the gap time constraint by operating such that the minimum gap time experience by the vehicle met or exceeded a threshold gap time. See the discussion of operation 518 for additional examples of performance metrics, any of which may be used as a constraint to define nominal vehicle behavior in such a manner, and operation 520 for additional examples of constraints. In some examples, the performance metric 416 may additionally or alternatively indicate such a performance metric as a rate, such as number of event(s) per distance traveled in the simulation and/or per time for which the vehicle was operated in the simulation. As discussed above, a simulation outcome 414 may be used to train and/or fine-tune machine-learned model 304. For example, at least part of the simulation outcome 414 may be used as ground truth for training the machine-learned model 304.

In some examples, the performance metric 416 may be used as part of determining an overall performance metric 418 that may additionally or alternatively be based on previous performance metric(s) 420 determined as result of any prior simulations conducted in testing the target component. In some examples, determining the overall performance metric may comprise determining a number or rate of events per simulated mile driven. In additional or alternate examples, determining the overall performance metric 418 may comprise an average or a cluster weighted average of the performance metric 416 and the previous performance metric(s) 420 for all of the simulations determined so far. In an example using the cluster weighted average, a cluster weight may be determined for each cluster. The cluster weight value may be determined based at least in part on a number of instances of scenario data associated with the cluster and/or a number of instances of scenario data sampled from the cluster. In some examples, the cluster weight value may be based at least in part on a percentage of the instances of scenario data associated with a cluster that have been sampled from the cluster. The cluster weight value may additionally or alternatively be determined per sample and may be based at least in part on a density of the cluster at a location from which the sample was determined. For example, the cluster weight may increase as the density of a region from which the sample was selected increases, and the cluster weight may be relatively decreased for a sample selected from a region of a cluster that has a lower density. Additionally or alternatively, the cluster weight value may be based at least in part on an average distance between embeddings in the cluster and/or a distance from a sampled embedding to a medoid or centroid of the cluster. In some examples, the cluster weight value may additionally or alternatively be based at least in part on a number of embeddings within a cluster and/or a number of clusters. For example, as the number of clusters increases, the variance between cluster weight values may be smaller, whereas as the number of clusters decreases, the variance between cluster weight values may increase.

The cluster weight value for a cluster may be multiplied with the performance metric(s) determined for any instances of scenario data sampled from that cluster. In some examples, the cluster weight may increase as the percentage decreases, as the number of instances of scenario data associated with the cluster increases, as the number of instances of scenario data sampled from the cluster decreases, or the like. In other words, the cluster weight may be used to account for the unsampled log data. For example, a cluster weight associated with cluster 408 may be lower than a cluster weight associated with cluster 412.

Additionally or alternatively, an average or cluster weighted average performance metric may be determined per cluster or per scenario attribute, such as an average or cluster weighted average performance metric for a real-world location, junction type (e.g., light controlled four-way junction, stop sign controlled T-junction), object classification and/or behavior (e.g., pedestrian crossing in front of the vehicle, cyclist in blind spot), and/or the like.

In some examples, a validation component may additionally or alternatively determine a confidence 426 associated with the overall performance metric 418. For example, a machine-learned model may determine a confidence score (e.g., a likelihood, which may be a posterior probability) based at least in part on the simulation outcome 414, previous outcome(s) 428, scenario data used to generate the simulations, and/or the performance metric(s). In an additional or alternate example, the confidence score may be a credible interval or confidence interval that may be determine based at least in part on Bayesian priors to estimate a width of a Bayesian below. For example, Bayesian inference may be used to determine a confidence distribution that may be updated based at least in part on subsequent simulation outcome(s) and/or performance metric(s). In an additional or alternate example, bootstrapping may be used to determine the confidence score. For example, this may include determining an estimated distribution or probability distribution based at least in part on the difficulty metric(s) for the subset of scenario data determined for simulation and using the simulation outcomes to modify a variance and/or confidence interval based at least in part on a difference between a distribution or probability distribution of occurrences corresponding the difficulty metrics in the simulation outcomes and the estimated distribution or probability distribution. In some examples, a confidence score or confidence interval may be determined per cluster and the sampling may continue until the confidence interval associated with each cluster meets or exceeds a threshold confidence score or exhibits a distribution having qualities defined by threshold statistical characteristics of a threshold confidence interval. The validation component may additionally or alternatively determine a variance or statistical distance based at least in part on the performance metrics determined for the instances of scenario data as part of the confidence score or as a separate metric. The variance and/or statistical distance may indicate how diversely the set of scenario data has been sampled and may be used as an indication that the overall performance metric 418 is (or is not) converging.

Additionally or alternatively, the validation component may determine a difference between the observed difficulty (e.g., number of simulations that resulted in a simulated vehicle contacting an object, comfort events, and/or degraded operation events) and average difficulty metric(s) of the set of scenario data or particular cluster(s) to determine whether to continue sampling or which cluster(s) to sample from. For example, if the difference meets or exceeds a threshold difference for a particular cluster, the validation component may trigger additional sampling for that cluster until the difference is less than a threshold difference or until a threshold number of additional samples have been simulated.

### Example Process for Sampling Scenario Data for Simulation and Uses Thereof

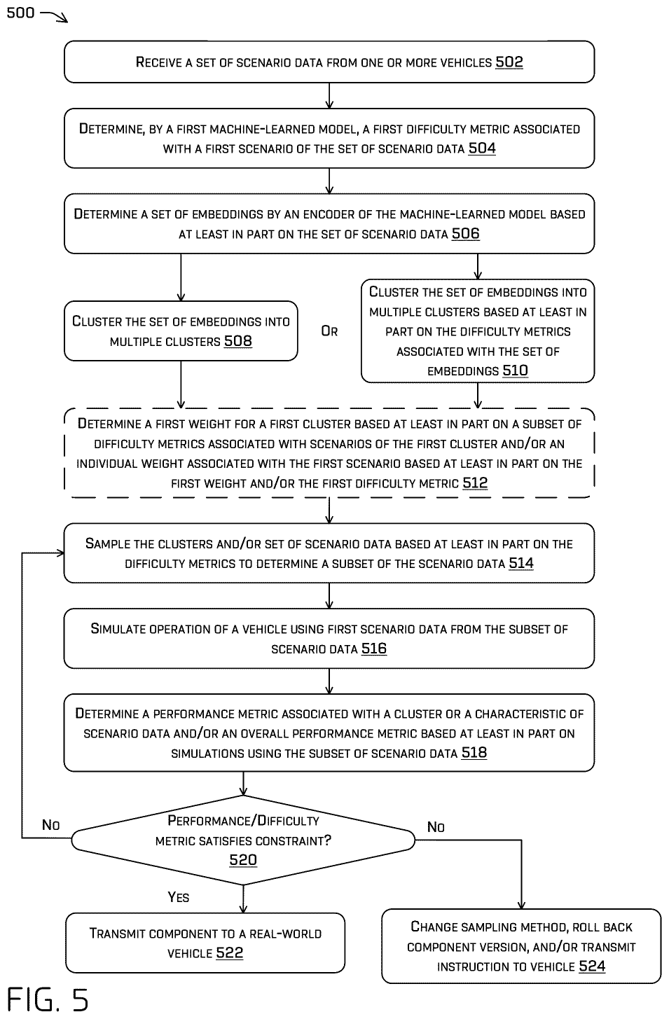

FIG. 5 illustrates a flow diagram of an example process 500 for generating simulations to validate and/or certify component(s) of an autonomous vehicle according to the techniques discussed herein. The operations in the process 500 may be executed in parallel, separately, in series, and/or performed by the same device or different devices. For example, the operations can be implemented by a computing device of a vehicle 202 and/or remote computing device(s) 214. Hardware and/or software components of a vehicle computing system may be configured to accomplish at least part of the example process 500, such as the simulation operations. For example, such simulations could comprise hardware and/or software-in-the-loop simulation.

In some examples, example process 500 may be preceded by receiving a vehicle component to be tested, according to any of the techniques discussed herein. This component may also be referred to herein as a target component and may include software and/or hardware. In some examples, receiving the component may comprise receiving a software copy and/or a computer simulation of hardware or installing hardware in a hardware-in-the-loop (HIL) configuration in conjunction with the simulation discussed herein. A computer simulation of hardware may model functionality of the hardware, including kinematic, processing, sensing, or other capabilities and/or constraints. Receiving an indication of the target component may comprise identifying a target component for testing and/or validation and, in examples where the target component is an updated or modified version of a former component, may identify the former component so that the example process 500 may prevent implementation of the target component and/or roll back to the former component if the target component is not validated as a result of example process 500.

At operation 502, example process 500 may comprise receiving a set of scenario data, according to any of the techniques discussed herein. For example, operation 502 may comprise receiving log data from one or more vehicles and segmenting the log data by time and/or event detection, receiving synthetic scenario data, and/or the like.

At operation 504, example process 500 may comprise determining, by a first machine-learned model, a first difficulty metric associated with a first scenario of the set of scenario data 504. As discussed above, operation 504 may comprise determining one or more difficulty metrics based at least in part on the first difficulty metric. Cumulatively, a difficulty metric may indicate a predicted likelihood that an adverse event (e.g., contact with an object, comfort event, degraded operation event) will occur during simulation of a scenario. Moreover, in some examples, operation 504 may include determining such difficulty metric(s) based at least in part on the first scenario data itself or an embedding determined by an encoder (e.g., as part of operation 506). The machine-learned model for generating the first difficulty metric may comprise a same or different backbone model as the encoder and may comprise one or more backbone models for generating the different difficulty metric. Regardless of the number of backbone models, an output head of a respective one of the model(s) may be trained to output a particular difficulty metric.

In some examples, the difficulty metric(s) may be used to determine a subset of the scenario data to simulate. The difficulty metric(s) may be used to determine the subset exclusively, or in combination with the operations described herein. For example, example process 500 may comprise determining instances of scenario data to include in the subset by determining the top n % of instances of scenario data in each difficulty metric ranked list or in an averaged difficulty metric ranked list, although the percentage taken from each list need not be the same, and including those top n % of instances in the subset, either as the entire subset or with additional additions to the subset determined as described below. Additionally or alternatively, example process 400 may comprise dispensing with determining the top n % of instances of scenario data and may purely use sampling the clusters as discussed below.

At operation 506, example process 500 may comprise determining a set of embeddings by a machine-learned model (e.g., an encoder, an embeddings model) based at least in part on the set of scenario data. This set of scenario data may comprise multiple instances of scenario data subsets and operation 504 may comprise determining a first embedding (e.g., vector, tensor) for a first scenario—e.g., operation 504 may comprise determining an embedding for up to each instance of scenario data in the set of scenario data. An instance of scenario data may be comprise a subset of log data, such as a 5, 10, 15, or 30 second series of log data received from a vehicle, synthetic data generated by a computing device, and/or the like. Accordingly, the set of embeddings generated at operation 504 may be a set of embeddings generated to represent the entire set of scenario data that may be simulated to test operation of the vehicle.

In some examples, the embedding determined by the machine-learned model using first scenario data at operation 506 may be used as input to the first machine-learned model for determining first difficulty metric(s) for the first scenario data at operation 504.

Example process 500 may continue to operation 508 in an example where the difficulty metric(s) aren't used as part of the clustering or to operation 510 in an example where the difficulty metric(s) are used to augment the clustering.

At operation 508, example process 500 may comprise clustering the set of embeddings into multiple clusters. Clustering the embeddings may include using k-means, k-medians, agglomerative clustering, mean shift clustering, DBSCAN, t-SNE, or the like to determine k number of clusters of the embeddings, where k is a positive integer. For example, such clustering may be based at least in part on the values of a respective embedding and/or the distance of an embedding from other embeddings in the embedding space. In some examples, k may be determined based at least in part on a previous batch of simulations used to test a component and may change depending on the particular component being tested. Additionally or alternatively, k may be a learned parameter as part of training the machine-learned model. For example, operation 508 may comprise determining boundaries of a cluster and/or determining whether to include an embedding in a cluster based at least in part on respective distances between an embedding and other embeddings contained within the boundaries of a cluster. Ultimately, operation 508 may result in determining a region and a subset of the set of embeddings determined at operation 506 that is contained within the region for each of the k clusters. In some examples, the clustering may allow for one or more embeddings to be outliers that have no cluster associated therewith. In such a case, such embeddings may have a special rule associated therewith that mandates that such embeddings are always sampled at operation 514, although in an additional or alternate example a zero or non-zero percentage of these embeddings may be sampled.

At operation 510, example process 500 may comprise clustering the set of embeddings into multiple clusters based at least in part on the difficulty metrics associated with the set of embeddings, according to any of the techniques discussed herein. In some examples, the operation 510 may comprise appending a vector indicating difficulty metric(s) determined for a first scenario to a first embedding determined for the first scenario. In such an example, the difficulty metric(s) may be indicated as values in the vector and may additionally or alternatively be scaled by a constant to increase a number of dimensions of the difficulty metric(s) vector before appending the difficulty metric(s) vector to the embedding.

At operation 512, example process 500 may comprise determining a first weight for a first cluster based at least in part on a subset of difficulty metrics associated with scenarios of the first cluster and/or an individual weight associated with the first scenario based at least in part on the first weight and/or the first difficulty metric determined for the first scenario, according to any of the techniques discussed herein. For example, operation 512 may comprise determining a sampling weight for a cluster that indicates a rate at which a cluster will be sampled (e.g., a percentage of the cluster's data that will be sampled, a number of scenarios that will be sampled from the cluster). Determining the sampling weight may comprise determining an average of the difficulty metrics associated with the subset of scenario data indicated as being associated with the cluster by the clustering operation discussed above. In some examples, this may comprise determining a weighted average of the difficulty metrics in examples where scenarios are each associated with multiple difficulty metrics (e.g., a contact likelihood may be weighted more in the averaging than the comfort event likelihood, degraded operation likelihood, estimated run-time, or the like). In some examples, operation 512 may be optional and is accordingly depicted in dashed lines. In some examples, operation 514 may additionally or alternatively comprise determining an average run-time for the cluster or the estimated run time may be left to be associated with individual scenarios. In an additional or alternate example, the average difficulty metric may be determined per difficulty metric type (e.g., average contact likelihood, average comfort event likelihood, average degraded operation event, average run time).

At operation 514, example process 500 may comprise sampling the clusters to determine a subset of the scenario data, according to any of the techniques discussed herein. This sampling may be random among the clusters (e.g., selecting a sample from any cluster randomly) and/or uniformly (e.g., a predetermined amount may be selected form each sample) sampled from the clusters of embeddings to determine instances of scenario data to be simulated by the simulation system. In some examples, sampling may exclude any previously sampled scenario data (i.e., the sampling may occur without replacement). In some examples, a minimum number of samples of scenario data may be sampled and/or a minimum number of samples from each cluster may be sampled or, in an example using random sampling, no minimum samples from each cluster may be enforced. In some examples, once this minimum number of samples has been sampled from each cluster, the sampling may continue to sample according to a pattern or may randomly select a cluster to sample from. Additionally or alternatively, after the minimum number of samples from each cluster has been sampled from each cluster, the sampling may determine the cluster to sampled from based at least in part on determining, for each cluster, an average difference in variance or confidence score that resulted from the last p number of samples sampled from a cluster and sampling from the cluster associated with a greatest average difference in variance or confidence score, where p is a positive integer. In some examples, the sampling rate for a particular cluster may be determined based at least in part on a sampling weight associated with the particular cluster.

In at least one example, the sampling may default to uniform sampling across the clusters, such as by sampling a minimum number from each cluster, which, for smaller cluster(s), may end up sampling the entire cluster. Additionally or alternatively, the sampling may comprise sampling a percentage or a lower or higher minimum number for a percentage of the clusters, according to the techniques discussed herein. For example, uniform sampling using a first minimum number may be used for 80% of the clusters, 5% of the clusters may be sampled using a percentage, 10% of the clusters may be sampled using a minimum number greater than the first minimum number, and 5% of the clusters may be sampled using a minimum number less than the first minimum number. These are only given as examples however, as any combination of uniform, percentage, or other sampling techniques may be used. For example, a cluster associated with a rate of an event that meets or exceeds a threshold rate (either as example process 500 proceeds or based on historical data associated with the cluster as determined by simulation using a previous version of the component) or an average difficulty metric that meets or exceeds a threshold difficulty metric may be sampled at a higher percentage.

Additionally or alternatively, the estimated run time difficulty metric may be treated separately during sampling. For example, the estimated run time (and/or other estimated computational time and/or resource predictions) may be excluded from determining the sampling weights until a threshold percentage of the sampling has already been accomplished (e.g., 50%, 80%, 90%, or even 100% in an example where run-time is only considered when extra sampling is to occur according to the determinations at operation 520). Once the threshold percentage has been met or exceeded, the estimated run time may be used to re-determine the sampling weights or the remaining unsampled scenarios may filtered to remove any scenarios associated with an estimated run time that meets or exceeds a threshold estimated run time. Additionally or alternatively, if the top n % of scenarios by difficulty metric(s) were determined to be added to the subset, the sampling may be determined from the remaining scenarios that weren't determined to be in the top n % of scenarios by difficulty metric(s).

At operation 516, example process 500 may comprise simulating operation of a vehicle (e.g., vehicle 202) using first scenario data from the subset of scenario data, according to the techniques discussed herein. Operation 516 may include iteratively simulating each scenario of the subset of scenario data sampled at operation 514 and/or determined using the top n % difficulty metric(s). Since the sampled instances of scenario data may be associated with a period of time, providing this scenario data as input may include streaming the scenario data to one or more components of the vehicle and simulating the position, orientation, state, velocity, acceleration, and/or the like of the vehicle based at least in part on outputs of one or more components of the vehicle that are responsive to the first scenario data. Operation 516 may comprise simulating operations of a vehicle based at least in part on operating the target component based at least in part on providing the first scenario data as input to the component or a component upstream from the component that provides output to the component, according to any of the techniques discussed herein.

At operation 518, example process 500 may comprise determining a performance metric based at least in part on the simulation, according to any of the techniques discussed herein. Operation 518 may comprise determining a number of times simulating operation of the vehicle using the target component resulted in a contact with an object, failing to detect an object, pausing, stopping, altering or ending a mission or route, idling, failing to determine an operation to control the vehicle, and/or the like. The performance metric may comprise any one or more of these individual metrics. In some examples, the performance metric may additionally or alternatively indicate such a performance metric per distance traveled in the simulation and/or time for which the vehicle was operated in the simulation. The performance metric may additionally or alternatively include any of the following, which may be determined from the simulation using the first instances of scenario data:
encroachment time (e.g., time period during which an object enters the vehicle's right of way),
gap time (e.g. time period between completion of encroachment by an object and the arrival time of vehicle if they continue with the same speed and path),
post-encroachment time (e.g., a time period between the end of an encroachment and the time that the vehicle arrives at the point that would have resulted in a collision),
initially-attempted post encroachment time (e.g., time period between the beginning of an encroachment plus the encroachment time and the expected time for the vehicle to reach the point of collision),
deceleration rate required to avoid a collision with an object,
a stopping distance required before colliding with an object,
a proportion between the remaining distance to the predicted point of collision to the minimum stopping distance as defined by a threshold distance,
time to collision (e.g., a predicted time before the vehicle collides with an object if they maintain their present speed and/or path),
a lateral distance to a closest object,
a longitudinal and/or lateral acceleration (whether acceleration or deceleration), and/or
a longitudinal and/or lateral jerk.

Operation 518 may additionally or alternatively include updating an overall performance metric based at least in part on the most recently determined performance metric, previously determined performance metric, and/or cluster weights associated with the clusters, as discussed above. In some examples, the performance metric may additionally or alternatively indicate a difference in the overall performance metric determined in simulation from a baseline performance metric, which may be determined from real-world and/or simulated operation of a prior version of the target component and/or the vehicle. Operation 518 may additionally or alternatively comprise determining an average or cluster weighted average performance metric associated with scenarios simulated from samples taken from a particular cluster or for scenarios sharing a same attribute, as discussed above. In other words, operation 518 may comprise determining one or more of an overall performance metric for all simulations executed, a performance metric per cluster (based on the simulations run using scenario data sampled from a particular cluster), and/or a performance metric for an attribute of the scenario data, such as a real-world location; vehicle maneuver and/or state; object classification, maneuver, and/or state; a roadway and/or junction type; and/or the like. In some examples, the attribute for which a performance metric may be determined may be a combination of attributes. Additionally or alternatively, the performance metric for an attribute or combination of attributes may be determined responsive to an attribute label being newly associated with scenario data, receiving a request for a performance metric to be determined for an attribute or combination of attributes, and/or the like.

As discussed above, multiple overall performance metrics or performance metrics per cluster or per attribute/combination of attributes may be determined. For example, the performance metrics for a given attribute/combination of attributes, a cluster, or all the simulations may include an indication of a number of events that occurred per simulated mile driven for different event types, such as how frequently the simulated vehicle contacted an object per simulated mile driven, how frequently the simulated vehicle came within a threshold distance of an object per simulated mile driven, how frequently the simulated vehicle failed to generate a trajectory to control the vehicle per simulated mile driven, etc.

In some examples, operation 518 may additionally or alternatively comprise generating a data structure, such as a pivot table, array, or the like, that indicates an attribute and/or combination of attributes and the performance metric determined for that attribute and/or combination of attributes. The data structure may additionally or alternatively indicate a region of the embedding space associated with a cluster, a performance metric associated with the cluster, and/or the embeddings of the scenario data.

In some examples, operation 518 may additionally or alternatively comprise determining a difference between an overall performance metric and/or a performance metric determined for a cluster determined by simulating operation of a current version of the component and a previous overall performance metric and/or a performance metric determined for the same cluster determined by simulating operation of a previous version of the component. This difference may additionally or alternatively be transmitted to the vehicle at operation 516 or operation 518.

In some examples, operation 518 may additionally or alternatively comprise determining a confidence score and/or variance based at least in part on the simulations executed so far, according to any of the techniques discussed herein. Operation 518 may comprise determining a confidence score (indicating a likelihood that the performance metric or overall performance metric is accurate) and/or variance associated with a last p number of simulations based at least in part on the simulation outcome, and/or the performance metric itself.

In some examples, operation 518 may additionally or alternatively comprise determining ground truth data for training the difficulty metric(s) machine-learned model by determining whether an event occurred that corresponds with a difficulty metric (e.g., the simulated vehicle contacted an object, the simulated vehicle violated a comfort threshold, the simulated vehicle operation during the simulation included degraded operation) and/or simulation computation details (e.g., a run time of the simulation and a processor speed/number of cores/number of cores used for the simulation, the maximum computational resources used for the simulation, such as a peak processors speed, a peak number of processor threads, a peak amount of memory, etc.). Operation 518 may additionally or alternatively comprise determining an observed difficulty metric associated with a simulation based on such data, which may be used to compare the observed difficulty metric to the predicted difficulty metric output by the machine-learned model using a particular scenario's data.

At operation 520, example process 600 may comprise determining whether the performance metric satisfies a constraint and/or whether a difficulty metric satisfies a constraint. For example, operation 520 may comprise determining whether the overall performance metric satisfies a safety criterion and/or efficacy criterion, according to any of the techniques discussed herein. Since the overall performance metric may include a set of overall performance metrics, operation 520 may comprise determining whether all or more than a threshold percentage of the overall performance metrics satisfy their respective safety and/or efficacy criterion. Satisfying the safety criterion and/or efficacy criterion may include, for example, determining that:
the rate per miles or time operated at which the simulated vehicle contacted an object was less than a threshold contact rate, failed to detect an object less than a threshold failed detection rate, paused less than a threshold pausing rate, stopped less than a threshold stopping rate, altered or ended a mission or route less than a threshold alteration/ending rate, idled less than a idling rate, failed to determine an operation to control the vehicle less than a threshold failure rate, and/or the like;
an average encroachment time is less than a threshold encroachment time;
an average gap time met or exceeded a threshold gap time;
an average post-encroachment time met or exceeded a threshold post-encroachment time;
an average deceleration rate required to avoid a collision with an object was less then a threshold deceleration rate;
an average or average maximum longitudinal and/or lateral acceleration was less than a threshold longitudinal and/or lateral acceleration and/or maximal acceleration,
determining that any one or more of the above overall performance metrics are an improvement over any one or more previous overall performance metrics of a previous version of a component (e.g., the number of contacts/failures/pauses/stops/alterations/idles/failures per miles driven went down compared to the previous overall performance metric, the average deceleration rate required to avoid a collision was less than the former average deceleration rate) and/or that no overall performance metrics degraded, and/or
the like.

Operation 520 may additionally or alternatively comprise determining whether an average observed difficulty metrics is within a threshold difference of the average predicted difficulty metrics associated with the subset of scenario data that has been simulated so far, or whether at least a threshold number of instances of scenario data that have been simulated so far are associated with observed difficulty metrics that are within a threshold difference of the predicted difficulty metrics for those instances. In other words, operation 520 may additionally or alternatively determine whether enough difficult scenarios have been simulated and/or whether the observed difficulty of the scenarios (as determined by determining event(s) corresponding to difficulty metric(s) occurred during simulation) is close to the predicted difficulty of the scenarios. For example, if less than a threshold number of scenarios resulted in observed difficulty metrics that were less than the predicted difficulty metrics by more than a threshold difference, operation 520 may comprise returning to operation 514 to sample more scenarios or increasing the percentage of the top m % of scenarios ranked by difficulty metric to include in the subset (where m is a positive integer greater than n, the original percentage of top scenarios selected for inclusion in the subset for simulation). In an additional or alternate example, example process 500 may return to operation 514 until a difference between the observed and predicted difficulty metric(s) is less than a threshold difference, until the average observed difficulty metric(s) (e.g., the total average, average for each difficulty metric type, or average for particular difficulty metric types) meets or exceeds threshold difficulty metric(s) (e.g., a total difficulty metric of the combined difficulty metrics, different threshold difficulty metrics for up to each of the different difficulty metric types), and/or until a threshold number of additional samples have been simulated. The latter example may occur if the component being tested has sufficiently improved that the observed difficulty metric(s) are unlikely to meet or exceed the threshold difficulty metric.

If all or at least a threshold percentage of the overall performance metrics satisfy their respective criterion and/or the overall observed difficulty metrics satisfy the difficulty metric criterion, example process 500 may proceed to operation 522. Otherwise, example process 500 may proceed to operation 524 or return to operation 514.

In some examples, this operation 520 may additionally or alternatively comprise determining a trend of the performance metric(s) and/or confidence score(s) and determining an extrapolation of the trend and/or a probability associated with the extrapolation. Determining an extrapolation of the trend may be used determine whether it is feasible for the overall performance metric will satisfy the criterion discussed at operation 520 before a maximum number of simulations has been conducted. For example, if enough negative events have already occurred in a small amount of simulations, there may be no way that the overall performance metric will satisfy the criterion at operation 520 or it may be very unlikely (as indicated by the probability). If this probability falls below a probability threshold or stays below the probability threshold for more than a predetermined number of simulations, example process 500 may be terminated early and an overall performance metric may be determined with the simulations that were run and/or the vehicle component that is being tested may be indicated as failing the testing. In such an example, example process 500 may continue to operation 524.

Additionally or alternatively, operation 520 may comprise determining whether a performance metric other than the overall performance metric satisfies the criterion or a constraint. For example, operation 520 may comprise determining cluster(s) for which a performance metric was determined that fails to satisfy the criterion or constraint. An indication of these cluster(s) and/or attribute(s) may be transmitted to the vehicle at operation 522. In an example where the performance metric associated with a cluster does not satisfy a criterion, a sampling rate associated with that cluster may be increased.

In some examples, operation 520 may additionally or alternatively comprise a precursor to operation 520 that comprises determining whether a confidence score associated with the overall performance metric meets or exceeds a confidence score threshold, the variance is less than a variance threshold, and/or the number of simulations run so far meets or exceeds a threshold number of simulations (in an example where such a minimum number is used), according to any of the techniques discussed herein. In examples using the minimum number of simulations, if that minimum number of simulations hasn't been achieved yet, example process 500 may return to operation 502 to determine a new set of log data and/or scenario data and/or operation 514 to determine new scenario(s) to use for another simulation, regardless of the confidence score and/or variance. Once the minimum number of simulations has been run, example process 500 may continue to return to operation 514 until one or both of the confidence score and the variance satisfy their respective thresholds. Once either or both of the confidence score and the variance satisfy their respective thresholds (e.g., confidence score meets or exceeds the confidence score threshold and/or variance is equal to or less than the variance threshold), example process 500 may execute operation 520. In examples where a minimum number of simulations isn't enforced, example process 500 may continue to operation 514 until either or both the confidence score and variance satisfy their respective thresholds, in which case example process 500 may continue to operation 520. In some examples, operation 520 may additionally or alternatively comprise determining that a maximum number of simulations have been run or a computing budget has been reached by the simulations run so far, in which case example process 500 may continue to operation 520.

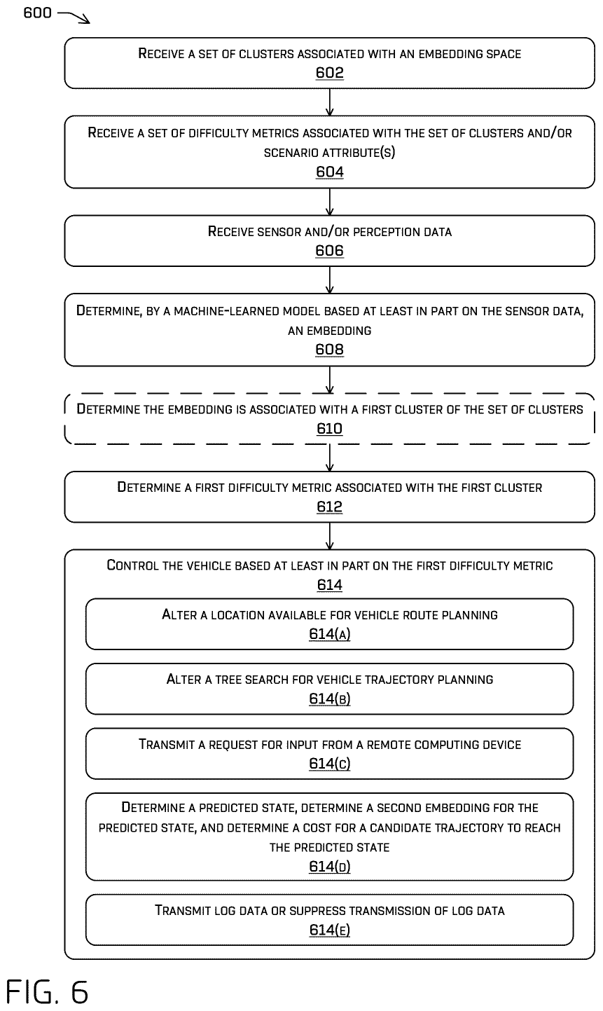

At operation 522, example process 500 may comprise transmitting the target component to the vehicle, implementing the target component on the vehicle (e.g., via physical or software installation), and/or controlling the vehicle using the target component, according to any of the techniques discussed herein. In some examples, operation 522 may additionally or alternatively comprise transmitting encoder, the difficulty metric(s) machine-learned model, and/or the data structure discussed above to the vehicle. For example, the data structure may indicate a cluster and the region the cluster occupies in the embedding space, a performance metric associated with the cluster, and/or an attribute or combination of attributes and a performance metric associated with the attribute or combination of attributes. As discussed in further detail regarding FIG. 6, the vehicle may use this data structure as part of controlling operations of the vehicle.

At operation 524, example process 500 may comprise indicating that the target component is not validated, transmitting an instruction to use a previous version of the target component (i.e., roll back a component version) or, where the target component has no previous version such as where the target component is a new component, controlling the vehicle according to a previous configuration, according to any of the techniques discussed herein. Additionally or alternatively, operation 524 may comprise transmitting the component, the encoder, and/or the data structure to the real-world vehicle, where the data structure may indicate which cluster(s) violate a constraint. Additionally or alternatively, operation 524 may comprise transmitting an instruction to the vehicle, such as an instruction to remove a real-world characteristic from a set of characteristics the vehicle is permitted to use for route-planning (effectively preventing the vehicle from planning a route that would take the vehicle to a scenario comprising that real-world characteristic), an instruction to cause a vehicle to operate in a real-world location (e.g., to gather additional log data from that real-world location), an instruction to down-weight (e.g., increase the cost of) a trajectory that would result in the vehicle and/or environment state matching a characteristic associated with a performance metric that does not satisfy the criterion, and/or the like. The techniques may additionally or alternatively comprise removing from a whitelist or adding to a blacklist other characteristic(s) of scenario data, such as a geographical region, a roadway configuration (e.g., 6-way intersection, roadway near a particular type of building), an area with high object density, or the like. Additionally or alternatively, operation 518 may comprise increasing a sampling rate associated with a cluster.

### Example Process for Using an Encoder and Embedding(S) to Control an Operation of the Vehicle

FIG. 6 illustrates a flow diagram of an example process 600 for controlling operation of a vehicle using the encoder and/or the machine-learned model for determining a difficulty metric discussed herein that may also be used for generating an embedding of sensor and/or perception data. The operations in the process 600 may be executed in parallel, separately, in series, and/or performed by the same device or different devices. For example, the operations can be implemented by a computing device of a vehicle 202 and/or remote computing device(s) 214. The vehicle 202 may store and execute the encoder (and aggregation layer, if there is one) of the machine-learned model 238. If such an encoder (and aggregation layer) is implemented in hardware, at least in part, the vehicle 202 may include such hardware.

At operation 602, example process 600 may comprise receiving a set of clusters associated with an embedding space, according to any of the techniques discussed herein. For example, operation 602 may comprise receiving an indication of a region of an embedding space associated with a cluster.

At operation 604, example process 600 may comprise receiving a set of difficulty metrics associated with the set of clusters, according to any of the techniques discussed herein. For example, operation 604 may comprise receiving an average difficulty metric associated with a particular cluster, as determined by operation(s) of example process 500. Additionally or alternatively, operation 604 may comprise receiving an attribute or combination of attributes and a performance metric determined for that cluster, as determined by operation(s) of example process 500. As discussed above, a performance metric may comprise one or more performance metrics associated with different event types and the difficulty metric may comprise one or more difficulty metrics.

At operation 606, example process 600 may comprise receiving sensor data, map data, and/or perception data at a vehicle that is configured with/stored and executes the encoder (and aggregation layer, if there is one), according to any of the techniques discussed herein. For example, the vehicle may receive sensor data and determine the perception data by a perception component of the vehicle using the sensor data. Operation 606 may additionally or alternatively comprise determining a characteristic associated with the sensor data, perception data, and/or map data. For example, operation 606 may comprise determining characteristics of a scenario comprising a geographical region associated with the log data (e.g., a city, neighborhood, or other sub-region of a geographical region, such as may be defined by a user-defined shape or street(s) or other geographical features that bound the sub-region), a label provided by a user, an environmental layout, a number, classification, and/or a position of object(s) in the environment and/or associate this definition with one or more portions of log data associated with that scenario. Additionally or alternatively, the characteristics may comprise object data indicated by perception data of the scenario, such as object data indicating at least one of a position of an object, a heading of the object, a classification of the object, a relative position of the object to the vehicle, or a movement classification of the object.

At operation 608, example process 600 may comprise determining, by a machine-learned model based at least in part on the sensor data and/or the perception data, an embedding, according to any of the techniques discussed herein. Additionally or alternatively operation 608 may comprise determining, by a machine-learned model and based at least in part on the sensor data and/or perception data, a difficulty metric. For example, the encoder (and aggregation layer, if there is one) of the machine-learned model 402 may determine the embedding using the sensor data and/or perception data and/or the machine-learned model 304 may determine the difficulty score. The encoder may be the same encoder used for example process 500 and, accordingly, is associated with a same embedding space as the clusters received at operation 602.

At operation 610, example process 600 may optionally comprise determining the embedding is associated with a first cluster of the set of clusters, according to any of the techniques discussed herein. For example, operation 610 may comprise determining that the embedding exists at a location that is within or within a threshold distance of a region identified by the first cluster or that the first cluster is the nearest cluster to the location of the embedding in the embedding space. Regarding the latter example, operation 610 may comprise determining that a boundary, medoid, or centroid of the first cluster is the closest cluster boundary, medoid, or centroid to the embedding. In some examples, operation 610 may be skipped if operation 608 comprises determining the difficulty metric directly.

At operation 612, example process 600 may comprise determining a first difficulty metric associated with the first cluster (from among the set of difficulty metrics associated with the set of cluster) if one wasn't determined directly at operation 608, according to any of the techniques discussed herein.

At operation 614, example process 600 may comprise controlling the vehicle based at least in part on the first difficulty metric, according to any of the techniques discussed herein. Operation 614 may comprise one or more of operations 614(A)-(D).

At operation 614(A), example process 600 may comprise altering a location available for vehicle route planning, according to any of the techniques discussed herein. For example, operation 614(A) may comprise removing a location in the environment from a set of candidate locations the vehicle may occupy. In some examples, this may comprise removing such a location from a set of locations for route-planning (e.g., such that the vehicle determines a route from a first location to a second location without traversing the blacklisted location) or from a set of candidate locations explored by a tree search for determining a trajectory to control the vehicle over a time horizon (e.g., the next 5, 10, or any other number of seconds) in examples where the difficulty metric meets or exceeds a threshold difficulty metric. Additionally or alternatively, where the difficulty metric is less than a threshold difficulty metric, the location may whitelisted (i.e., allowed for route/trajectory planning) and/or may be promoted by reducing a cost in the tree search associated with trajectory (ies) generated by the tree search that reach the location.

At operation 614(B), example process 600 may comprise altering a tree search for vehicle trajectory planning, according to any of the techniques discussed herein. For example, if the difficulty metric meets or exceeds a threshold difficulty metric, operation 614(B) may comprise increasing parameter(s) controlling an extent to which the vehicle 202 operates conservatively, increasing computational resources allocated to the tree search, increasing a number of candidate trajectory (ies) and/or predicted states explored by the tree search, increasing a cost determined for a candidate trajectory generated by a tree search, removing a location from a set of locations the vehicle is permitted to use for trajectory planning, and/or the like. If the difficulty metric is less than a threshold difficulty metric, a number of candidate trajectory (ies) and/or predicted states explored by the tree search may be reduced, a cost associated with a candidate trajectory may be reduced, a location may be added to a set of locations the vehicle is permitted to use for trajectory planning, and/or the like. Operation 614(B) may additionally or alternatively include operation 614(D). In some examples, operation 614(C) may additionally or alternatively comprise otherwise altering operation of the vehicle, such as by modify availability of one or more driving maneuvers for selection, altering a maximum speed and/or acceleration the vehicle may operate at, etc.

At operation 614(C), example process 600 may comprise transmitting a request for input from a remote computing device, according to any of the techniques discussed herein. For example, if the difficulty metric meets or exceeds a threshold difficulty metric, operation 614(C) may comprise transmitting a request for input from a teleoperations device.

At operation 614(D), example process 600 may comprise determining a predicted state, determining a second embedding for the predicted state, and determining a cost for a candidate trajectory to reach the predicted state based at least in part on the second embedding and difficulty metric(s) associated therewith, according to any of the techniques discussed herein. For example, operation 614(D) may comprise receiving a predicted state of the vehicle from a prediction component of the vehicle, where the predicted state indicates a future state (e.g., position, orientation, velocity, acceleration) of the vehicle and/or of object(s) in the environment. Additionally or alternatively, the predicted state may be received from a tree search. The encoder may determine a second embedding based at least in part on the predicted state and operation 614(D) may comprise determining a cluster that the second embedding is located within or within a threshold distance of and determining a second difficulty metric associated with the cluster. If this second difficulty metric meets or exceeds a threshold difficulty metric, a candidate trajectory that reaches the predicted state may be suppressed or down-weighted (e.g., such as by increasing a cost associated with the candidate trajectory by multiplying, by a scalar value greater than 1, a cost determined for the candidate trajectory by the tree search). Additionally or alternatively, if the second difficulty metric is less than a threshold difficulty metric, the candidate trajectory that reaches the predicted state may be promoted, such as by reducing a cost associated with the candidate trajectory (e.g., by multiplying the cost by a scalar value that is less than 1). In an example where the predicted state was received after a trajectory was determined by the planning component and the second metric is meets or exceeds a threshold difficulty metric, operation 614(D) may comprise triggering the planning component to discard the trajectory and re-determine a new trajectory for controlling the vehicle.

In some examples, an embedding may be determined for a predicted state for less than all of the candidate trajectories generated by the tree search. For example, such embeddings and process may be used when the first difficulty metric determined for the current sensor data and/or prediction data meets or exceeds a threshold difficulty metric. Additionally or alternatively, an embedding may be generated for a predicted state every n number of layers of the tree search (where n is a positive integer, for predicted states resulting from a candidate trajectory having a preliminary cost that is below a threshold cost, and/or for default candidate trajectory (ies), which may include trajectories such as using a last trajectory selected by the tree search, a canonic lane change trajectory, a canonic right/left-turn trajectory, a canonic hard braking trajectory, etc.

At operation 614(E), example process 600 may comprise determining to transmit log data associated with a time period or suppressing transmission of log data associated with a time period. For example, operation 614(E) may comprise transmitting the log data if the difficulty metric meets or exceeds a threshold difficulty metric or suppressing transmission of the log data if the difficulty metric is less than a threshold difficulty metric. In some examples, the time window of log data transmitted or suppressed from transmission may be based on a static time window from a current time to a time in the past, or may be based at least in part on an average difficulty metric, and/or a variance or trend of the difficulty metric over time. For example, the time window of the log data transmitted may comprise log data for which the average difficulty metric was above an average difficulty metric threshold or may be a range from the current time to with a time at which the difficulty metric and/or an average or variance thereof started to trend towards the threshold (e.g., which may include determining a point of inflection or other trend indicators). The time window to suppress may be determined inversely (e.g., a time window over which the average difficulty metric was less than a threshold difficulty metric or a time at which the difficulty metric inflected).

### Example Clauses

A: A system comprising: one or more processors; and one or more non-transitory memory storing processor-executable instructions that, when executed by the one or more processors, cause the system to perform operations comprising: receiving a set of scenario data; determining, by a machine-learned model and based at least in part on first scenario data of the set of scenario data, a difficulty metric indicating an estimated likelihood of an adverse event occurring during a simulation of operation of a simulated vehicle using the first scenario data; determining to include the first scenario data in a subset of the set of scenario data based at least in part on the difficulty metric; simulating, based at least in part on the subset of the set of scenario data, operation of a component of a vehicle; determining a performance metric based at least in part on the simulating, wherein determining the performance metric comprises determining a first performance metric based at least in part on simulating operation of the vehicle using the first scenario data; and transmitting the component to an autonomous vehicle.
B: The system of paragraph A, wherein the operations further comprise: inputting, into an encoder, the set of scenario data; receiving, from the encoder, a set of embeddings; clustering the set of embeddings into multiple clusters, wherein a first cluster of the multiple clusters is associated with a first group of scenarios of the set of scenario data, wherein determining the subset is further based at least in part on sampling scenario data from the multiple clusters.
C: The system of paragraph B, wherein clustering the set of embeddings into the multiple clusters is based at least in part on difficulty metrics associated with the set of embeddings.
D: The system of paragraph C, wherein sampling the first scenario data from the first cluster is further based at least in part on a sampling weight associated with the first scenario data or the first cluster that is determined based at least in part on at least one of the difficulty metric or a subset of the difficulty metrics associated with the first group of scenarios associated with the first cluster.
E: The system of any one of paragraphs A-D, wherein the operations further comprise: determining, by a second machine-learned model and based at least in part on a first embedding determined for the first scenario data, an estimated run time associated with simulating the first scenario data, wherein determining the subset of the set of scenario data is further based at least in part on the estimated run time.
F: The system of any one of paragraphs A-E, wherein the difficulty metric comprises at least one of: a first likelihood that simulating operation of the vehicle in a first scenario generated using the first scenario data will result in the vehicle contacting an object; a second likelihood that simulating operation of the vehicle in the first scenario will result in an acceleration or jerk of the vehicle that meets or exceeds a threshold acceleration or threshold jerk; or a third likelihood that simulating operation of the vehicle in the first scenario will result in the vehicle idling, altering or ending a mission, or violating an operating constraint.
G: One or more non-transitory computer-readable media storing processor-executable instructions that, when executed by one or more processors, cause the one or more processors to perform operations comprising: receiving a set of scenario data; determining, by a machine-learned model and based at least in part on first scenario data of the set of scenario data, a difficulty metric indicating an estimated likelihood of an adverse event occurring during a simulation of operation of a simulated vehicle using the first scenario data; determining to include the first scenario data in a subset of the set of scenario data based at least in part on the difficulty metric; simulating, based at least in part on the subset of the set of scenario data, operation of a component of a vehicle; determining a performance metric based at least in part on the simulating, wherein determining the performance metric comprises determining a first performance metric based at least in part on simulating operation of the vehicle using the first scenario data; and transmitting the component to an autonomous vehicle.
H: The one or more non-transitory computer-readable media of paragraph G, wherein the operations further comprise: inputting, into an encoder, the set of scenario data; receiving, from the encoder, a set of embeddings; clustering the set of embeddings into multiple clusters, wherein a first cluster of the multiple clusters is associated with a first group of scenarios of the set of scenario data, wherein determining the subset is further based at least in part on sampling scenario data from the multiple clusters.
I: The one or more non-transitory computer-readable media of paragraph H, wherein clustering the set of embeddings into the multiple clusters is based at least in part on difficulty metrics associated with the set of embeddings.
J: The one or more non-transitory computer-readable media of paragraph I, wherein sampling the first scenario data from the first cluster is further based at least in part on a sampling weight associated with the first scenario data or the first cluster that is determined based at least in part on at least one of the difficulty metric or a subset of the difficulty metrics associated with the first group of scenarios associated with the first cluster.
K: The one or more non-transitory computer-readable media of any one of paragraphs H-J, wherein determining the subset of the set of scenario data comprises determining a first subset of scenario data based at least in part on difficulty metrics associated with the first subset and determining a second subset of scenario data based at least in part on sampling the clusters.
L: The one or more non-transitory computer-readable media of any one of paragraphs G-K, wherein the operations further comprise: determining, by a second machine-learned model and based at least in part on a first embedding determined for the first scenario data, an estimated run time associated with simulating the first scenario data, wherein determining the subset of the set of scenario data is further based at least in part on the estimated run time.
M: The one or more non-transitory computer-readable media of any one of paragraphs G-L, wherein the difficulty metric comprises at least one of: a first likelihood that simulating operation of the vehicle in a first scenario generated using the first scenario data will result in the vehicle contacting an object; a second likelihood that simulating operation of the vehicle in the first scenario will result in an acceleration or jerk of the vehicle that meets or exceeds a threshold acceleration or threshold jerk; or a third likelihood that simulating operation of the vehicle in the first scenario will result in the vehicle idling, altering or ending a mission, or violating an operating constraint.
N: A method comprising: receiving a set of scenario data; determining, by a machine-learned model and based at least in part on first scenario data of the set of scenario data, a difficulty metric indicating an estimated likelihood of an adverse event occurring during a simulation of operation of a simulated vehicle using the first scenario data; determining to include the first scenario data in a subset of the set of scenario data based at least in part on the difficulty metric; simulating, based at least in part on the subset of the set of scenario data, operation of a component of a vehicle; determining a performance metric based at least in part on the simulating, wherein determining the performance metric comprises determining a first performance metric based at least in part on simulating operation of the vehicle using the first scenario data; and transmitting the component to an autonomous vehicle.
O: The method of paragraph N, further comprising: inputting, into an encoder, the set of scenario data; receiving, from the encoder, a set of embeddings; clustering the set of embeddings into multiple clusters, wherein a first cluster of the multiple clusters is associated with a first group of scenarios of the set of scenario data, wherein determining the subset is further based at least in part on sampling scenario data from the multiple clusters.
P: The method of paragraph O, wherein clustering the set of embeddings into the multiple clusters is based at least in part on difficulty metrics associated with the set of embeddings.
Q: The method of paragraph P, wherein sampling the first scenario data from the first cluster is further based at least in part on a sampling weight associated with the first scenario data or the first cluster that is determined based at least in part on at least one of the difficulty metric or a subset of the difficulty metrics associated with the first group of scenarios associated with the first cluster.
R: The method of any one of paragraphs O-Q, wherein determining the subset of the set of scenario data comprises determining a first subset of scenario data based at least in part on difficulty metrics associated with the first subset and determining a second subset of scenario data based at least in part on sampling the clusters.
S: The method of any one of paragraphs N-R, further comprising: determining, by a second machine-learned model and based at least in part on a first embedding determined for the first scenario data, an estimated run time associated with simulating the first scenario data, wherein determining the subset of the set of scenario data is further based at least in part on the estimated run time.
T: The method of any one of paragraphs N-S, wherein the difficulty metric comprises at least one of: a first likelihood that simulating operation of the vehicle in a first scenario generated using the first scenario data will result in the vehicle contacting an object; a second likelihood that simulating operation of the vehicle in the first scenario will result in an acceleration or jerk of the vehicle that meets or exceeds a threshold acceleration or threshold jerk; or a third likelihood that simulating operation of the vehicle in the first scenario will result in the vehicle idling, altering or ending a mission, or violating an operating constraint.
U: A system comprising: one or more processors; and one or more non-transitory memory storing processor-executable instructions that, when executed by the one or more processors, cause the system to perform operations comprising: receiving a set of clusters associated with an embedding space, wherein a first cluster of the set of clusters identifies a region in the embedding space associated with embeddings generated by a machine-learned model using a set of scenario data determined based at least in part on sensor data received from a first vehicle; receiving a set of difficulty metrics associated with the set of clusters, wherein a first difficulty metric is associated with the first cluster and indicates an average predicted likelihood that an adverse event will occur during simulation of operation of a simulated vehicle in a subset of simulated scenarios associated with the first cluster; receiving sensor data at a second vehicle; determining, by the machine-learned model based at least in part on the sensor data, an embedding; determining that the embedding is associated with the region identified by the first cluster; and controlling the second vehicle based at least in part on the first difficulty metric.
V: The system of paragraph U, wherein: the machine-learned model determined embeddings for the subset of simulated scenarios; the first cluster was determined based at least in part on the embeddings; and the embeddings are located within the region indicated by the first cluster.
W: The system of either paragraph U or V, wherein: the operations further comprise determining that the first difficulty metric violates a constraint, wherein violating the constraint comprises at least one of the first difficulty metric meeting or exceeding a threshold difficulty metric or an average difficulty metric across difficulty metrics determined for other clusters; and controlling the second vehicle based at least in part on the first difficulty metric comprises at least one of: removing a location from a set of locations the second vehicle is permitted to use for trajectory planning; increasing processing or memory allocation for operation planning by the second vehicle; increasing a cost associated with a candidate trajectory or removing the candidate trajectory from a set of candidate trajectories; increasing a number of the set of candidate trajectories; removing a maneuver from a set of maneuvers available for controlling the second vehicle; decreasing at least one of a maximum speed or a maximum acceleration for controlling the second vehicle; transmitting log data comprising at least part of the sensor data to a remote computing device; or transmitting a request for input from the remote computing device.
X: The system of any one of paragraphs U-W, wherein: the operations further comprise determining that the first difficulty metric satisfies a constraint, wherein satisfying the constraint comprises at least one of the first difficulty metric being at or below a threshold difficulty metric or an average difficulty metric across difficulty metrics determined for other clusters; and controlling the second vehicle based at least in part on the first difficulty metric comprises at least one of: decreasing a cost associated with a candidate trajectory; adding a location to a set of locations the second vehicle is permitted to use for trajectory planning; adding a maneuver to a set of maneuvers available for controlling the second vehicle; decreasing a number of a set of candidate trajectories; or suppressing submission of log data to a remote computing device.
Y: The system of any one of paragraphs U-X, wherein the machine-learned model is a first machine-learned model and the operations further comprise: receiving a candidate trajectory for controlling the second vehicle; determining, by a second machine-learned model, a predicted state of a set of objects; determining, by the first machine-learned model and based at least in part on the predicted state, a second embedding; and determining that the second embedding is associated with the region identified by the first cluster, wherein controlling the second vehicle based at least in part on the first difficulty metric comprises: discarding or increasing a cost associated with the candidate trajectory based at least in part on determining that the first difficulty metric meets or exceeds a threshold difficulty metric, or decreasing a cost associated with the candidate trajectory based at least in part on determining that the first difficulty metric is less than the threshold difficulty metric.
Z: The system of paragraph Y, wherein determining the second embedding is further based at least in part on one or more of: a preliminary cost associated with the candidate trajectory being below a threshold cost; a layer of a tree search associated with the candidate trajectory comprises a multiple of n, where n is a positive integer; or the candidate trajectory comprises a default candidate trajectory from among a set of default trajectories.
AA: One or more non-transitory computer-readable media storing processor-executable instructions that, when executed by one or more processors, cause the one or more processors to perform operations comprising: receiving a set of clusters associated with an embedding space, wherein a first cluster of the set of clusters identifies a region in the embedding space associated with embeddings generated by a machine-learned model using a set of scenario data determined based at least in part on sensor data received from a first vehicle; receiving a set of difficulty metrics associated with the set of clusters, wherein a first difficulty metric is associated with the first cluster and indicates an average predicted likelihood that an adverse event will occur during simulation of operation of a simulated vehicle in a subset of simulated scenarios associated with the first cluster; receiving sensor data at a second vehicle; determining, by the machine-learned model based at least in part on the sensor data, an embedding; determining that the embedding is associated with the region identified by the first cluster; and controlling the second vehicle based at least in part on the first difficulty metric.
AB: The one or more non-transitory computer-readable media of paragraph AA, wherein: the machine-learned model determined embeddings for the subset of simulated scenarios; the first cluster was determined based at least in part on the embeddings; and the embeddings are located within the region indicated by the first cluster.
AC: The one or more non-transitory computer-readable media of either paragraph AA or AB, wherein: the operations further comprise determining that the first difficulty metric violates a constraint, wherein violating the constraint comprises at least one of the first difficulty metric meeting or exceeding a threshold difficulty metric or an average difficulty metric across difficulty metrics determined for other clusters; and controlling the second vehicle based at least in part on the first difficulty metric comprises at least one of: removing a location from a set of locations the second vehicle is permitted to use for trajectory planning; increasing processing or memory allocation for operation planning by the second vehicle; increasing a cost associated with a candidate trajectory or removing the candidate trajectory from a set of candidate trajectories; increasing a number of the set of candidate trajectories; removing a maneuver from a set of maneuvers available for controlling the second vehicle; decreasing at least one of a maximum speed or a maximum acceleration for controlling the second vehicle; transmitting log data comprising at least part of the sensor data to a remote computing device; or transmitting a request for input from the remote computing device.
AD: The one or more non-transitory computer-readable media of any one of paragraphs AA-AC, wherein: the operations further comprise determining that the first difficulty metric satisfies a constraint, wherein satisfying the constraint comprises at least one of the first difficulty metric being at or below a threshold difficulty metric or an average difficulty metric across difficulty metrics determined for other clusters; and controlling the second vehicle based at least in part on the first difficulty metric comprises at least one of: decreasing a cost associated with a candidate trajectory; adding a location to a set of locations the second vehicle is permitted to use for trajectory planning; adding a maneuver to a set of maneuvers available for controlling the second vehicle; decreasing a number of a set of candidate trajectories; or suppressing submission of log data to a remote computing device.
AE: The one or more non-transitory computer-readable media of any one of paragraphs AA-AD, wherein the machine-learned model is a first machine-learned model and the operations further comprise: receiving a candidate trajectory for controlling the second vehicle; determining, by a second machine-learned model, a predicted state of a set of objects; determining, by the first machine-learned model and based at least in part on the predicted state, a second embedding; and determining that the second embedding is associated with the region identified by the first cluster, wherein controlling the second vehicle based at least in part on the first difficulty metric comprises: discarding or increasing a cost associated with the candidate trajectory based at least in part on determining that the first difficulty metric meets or exceeds a threshold difficulty metric, or decreasing a cost associated with the candidate trajectory based at least in part on determining that the first difficulty metric is less than the threshold difficulty metric.
AF: The one or more non-transitory computer-readable media of paragraph AE, wherein determining the second embedding is further based at least in part on one or more of: a preliminary cost associated with the candidate trajectory being below a threshold cost; a layer of a tree search associated with the candidate trajectory comprises a multiple of n, where n is a positive integer; or the candidate trajectory comprises a default candidate trajectory from among a set of default trajectories.
AG: The one or more non-transitory computer-readable media of any one of paragraphs AA-AF, wherein determining the embedding is associated with the region comprises determining: the embedding is within the region, the embedding is within a threshold distance of a portion of the region, or the first cluster is a nearest cluster to the embedding from among the set of clusters.
AH: The one or more non-transitory computer-readable media of any one of paragraphs AA-AG, wherein the first difficulty metric comprises at least one of: a first likelihood that simulating operation of the second vehicle in a first scenario of the set of scenario data will result in the second vehicle contacting an object; a second likelihood that simulating operation of the second vehicle in the first scenario will result in an acceleration or jerk of the second vehicle that meets or exceeds a threshold acceleration or threshold jerk; or a third likelihood that simulating operation of the second vehicle in the first scenario will result in the second vehicle idling, altering or ending a mission, or violating an operating constraint.
AI: A method comprising: receiving a set of clusters associated with an embedding space, wherein a first cluster of the set of clusters identifies a region in the embedding space associated with embeddings generated by a machine-learned model using a set of scenario data determined based at least in part on sensor data received from a first vehicle; receiving a set of difficulty metrics associated with the set of clusters, wherein a first difficulty metric is associated with the first cluster and indicates an average predicted likelihood that an adverse event will occur during simulation of operation of a simulated vehicle in a subset of simulated scenarios associated with the first cluster; receiving sensor data at a second vehicle; determining, by the machine-learned model based at least in part on the sensor data, an embedding; determining that the embedding is associated with the region identified by the first cluster; and controlling the second vehicle based at least in part on the first difficulty metric.
AJ: The method of paragraph AI, wherein: the machine-learned model determined embeddings for the subset of simulated scenarios; the first cluster was determined based at least in part on the embeddings; and the embeddings are located within the region indicated by the first cluster.
AK: The method of either paragraph AI or AJ, wherein: the method further comprises determining that the first difficulty metric violates a constraint, wherein violating the constraint comprises at least one of the first difficulty metric meeting or exceeding a threshold difficulty metric or an average difficulty metric across difficulty metrics determined for other clusters; and controlling the second vehicle based at least in part on the first difficulty metric comprises at least one of: removing a location from a set of locations the second vehicle is permitted to use for trajectory planning; increasing processing or memory allocation for operation planning by the second vehicle; increasing a cost associated with a candidate trajectory or removing the candidate trajectory from a set of candidate trajectories; increasing a number of the set of candidate trajectories; removing a maneuver from a set of maneuvers available for controlling the second vehicle; decreasing at least one of a maximum speed or a maximum acceleration for controlling the second vehicle; transmitting log data comprising at least part of the sensor data to a remote computing device; or transmitting a request for input from the remote computing device.
AL: The method of any one of paragraphs AI-AK, wherein: the method further comprises determining that the first difficulty metric satisfies a constraint, wherein satisfying the constraint comprises at least one of the first difficulty metric being at or below a threshold difficulty metric or an average difficulty metric across difficulty metrics determined for other clusters; and controlling the second vehicle based at least in part on the first difficulty metric comprises at least one of: decreasing a cost associated with a candidate trajectory; adding a location to a set of locations the second vehicle is permitted to use for trajectory planning; adding a maneuver to a set of maneuvers available for controlling the second vehicle; decreasing a number of a set of candidate trajectories; or suppressing submission of log data to a remote computing device.
AM: The method of any one of paragraphs AI-AL, wherein the machine-learned model is a first machine-learned model and the method further comprises: receiving a candidate trajectory for controlling the second vehicle; determining, by a second machine-learned model, a predicted state of a set of objects; determining, by the first machine-learned model and based at least in part on the predicted state, a second embedding; and determining that the second embedding is associated with the region identified by the first cluster, wherein controlling the second vehicle based at least in part on the first difficulty metric comprises: discarding or increasing a cost associated with the candidate trajectory based at least in part on determining that the first difficulty metric meets or exceeds a threshold difficulty metric, or decreasing a cost associated with the candidate trajectory based at least in part on determining that the first difficulty metric is less than the threshold difficulty metric.
AN: The method of paragraph AM, wherein determining the second embedding is further based at least in part on one or more of: a preliminary cost associated with the candidate trajectory being below a threshold cost; a layer of a tree search associated with the candidate trajectory comprises a multiple of n, where n is a positive integer; or the candidate trajectory comprises a default candidate trajectory from among a set of default trajectories.

While the example clauses described above are described with respect to one particular implementation, it should be understood that, in the context of this document, the content of the example clauses can also be implemented via a method, device, system, computer-readable medium, and/or another i006Dplementation. Additionally, any of examples A-AN may be implemented alone or in combination with any other one or more of the examples A-AN.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code components and/or computer-executable instructions executed by one or more computers or processors, hardware, or some combination thereof. Some or all of the methods may alternatively be embodied in specialized computer hardware.

At least some of the processes discussed herein are illustrated as logical flow graphs, each operation of which represents a sequence of operations that can be implemented in hardware, software, or a combination thereof. In the context of software, the operations represent computer-executable instructions stored on one or more non-transitory computer-readable storage media that, when executed by one or more processors, cause a computer or autonomous vehicle to perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. Such processes, or any portion thereof, may be performed iteratively in that any or all of the steps may be repeated. Of course, the disclosure is not meant to be so limiting and, as such, any process performed iteratively may comprise, in some examples, performance of the steps a single time.

Conditional language such as, among others, “may,” “could,” “may” or “might,” unless specifically stated otherwise, are understood within the context to indicate that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a,” “an” or other similar articles means singular and/or plural. When referring to a collection of item as a “set,” it should be understood that the definition may include, but is not limited to, the common understanding of the term in mathematics to include any number of items including a null set (0), 1, 2, 3, . . . up to and including an infinite set.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art. Note that the term substantially may indicate a range. For example, substantially simultaneously may indicate that two activities occur within a time range of each other, substantially a same dimension may indicate that two elements have dimensions within a range of each other, and/or the like.

Many variations and modifications may be made to the above-described examples, the elements of which are to be understood as being among other acceptable examples. All such modifications and variations are intended to be included herein within the scope of this disclosure and protected by the following claims.

What is claimed is:

1. A system comprising:
one or more processors; and
one or more non-transitory memory storing processor-executable instructions that, when executed by the one or more processors, cause the system to perform operations comprising:
receiving a set of clusters associated with an embedding space, wherein a first cluster of the set of clusters identifies a region in the embedding space associated with embeddings generated by a machine-learned model using a set of scenario data determined based at least in part on sensor data received from a first vehicle;
receiving a set of difficulty metrics associated with the set of clusters, wherein a first difficulty metric is associated with the first cluster and indicates an average predicted likelihood that an adverse event will occur during simulation of operation of a simulated vehicle in a subset of simulated scenarios associated with the first cluster;
receiving sensor data at a second vehicle;
determining, by the machine-learned model based at least in part on the sensor data, an embedding;
determining that the embedding is associated with the region identified by the first cluster; and
controlling the second vehicle based at least in part on the first difficulty metric.

2. The system of claim 1, wherein:
the machine-learned model determined embeddings for the subset of simulated scenarios;
the first cluster was determined based at least in part on the embeddings; and
the embeddings are located within the region indicated by the first cluster.

3. The system of claim 1, wherein:
the operations further comprise determining that the first difficulty metric violates a constraint, wherein violating the constraint comprises at least one of the first difficulty metric meeting or exceeding a threshold difficulty metric or an average difficulty metric across difficulty metrics determined for other clusters; and
controlling the second vehicle based at least in part on the first difficulty metric comprises at least one of:
removing a location from a set of locations the second vehicle is permitted to use for trajectory planning;
increasing processing or memory allocation for operation planning by the second vehicle;
increasing a cost associated with a candidate trajectory or removing the candidate trajectory from a set of candidate trajectories;
increasing a number of the set of candidate trajectories;
removing a maneuver from a set of maneuvers available for controlling the second vehicle;
decreasing at least one of a maximum speed or a maximum acceleration for controlling the second vehicle;
transmitting log data comprising at least part of the sensor data to a remote computing device; or
transmitting a request for input from the remote computing device.

4. The system of claim 1, wherein:
the operations further comprise determining that the first difficulty metric satisfies a constraint, wherein satisfying the constraint comprises at least one of the first difficulty metric being at or below a threshold difficulty metric or an average difficulty metric across difficulty metrics determined for other clusters; and
controlling the second vehicle based at least in part on the first difficulty metric comprises at least one of:
decreasing a cost associated with a candidate trajectory;
adding a location to a set of locations the second vehicle is permitted to use for trajectory planning;
adding a maneuver to a set of maneuvers available for controlling the second vehicle;
decreasing a number of a set of candidate trajectories; or
suppressing submission of log data to a remote computing device.

5. The system of claim 1, wherein the machine-learned model is a first machine-learned model and the operations further comprise:
receiving a candidate trajectory for controlling the second vehicle;
determining, by a second machine-learned model, a predicted state of a set of objects;
determining, by the first machine-learned model and based at least in part on the predicted state, a second embedding; and
determining that the second embedding is associated with the region identified by the first cluster,
wherein controlling the second vehicle based at least in part on the first difficulty metric comprises:
discarding or increasing a cost associated with the candidate trajectory based at least in part on determining that the first difficulty metric meets or exceeds a threshold difficulty metric, or
decreasing a cost associated with the candidate trajectory based at least in part on determining that the first difficulty metric is less than the threshold difficulty metric.

6. The system of claim 5, wherein determining the second embedding is further based at least in part on one or more of:
a preliminary cost associated with the candidate trajectory being below a threshold cost;
a layer of a tree search associated with the candidate trajectory comprises a multiple of n, where n is a positive integer; or
the candidate trajectory comprises a default candidate trajectory from among a set of default trajectories.

7. One or more non-transitory computer-readable media storing processor-executable instructions that, when executed by one or more processors, cause the one or more processors to perform operations comprising:
receiving a set of clusters associated with an embedding space, wherein a first cluster of the set of clusters identifies a region in the embedding space associated with embeddings generated by a machine-learned model using a set of scenario data determined based at least in part on sensor data received from a first vehicle;
receiving a set of difficulty metrics associated with the set of clusters, wherein a first difficulty metric is associated with the first cluster and indicates an average predicted likelihood that an adverse event will occur during simulation of operation of a simulated vehicle in a subset of simulated scenarios associated with the first cluster;
receiving sensor data at a second vehicle;
determining, by the machine-learned model based at least in part on the sensor data, an embedding;
determining that the embedding is associated with the region identified by the first cluster; and
controlling the second vehicle based at least in part on the first difficulty metric.

8. The one or more non-transitory computer-readable media of claim 7, wherein:
the machine-learned model determined embeddings for the subset of simulated scenarios;
the first cluster was determined based at least in part on the embeddings; and
the embeddings are located within the region indicated by the first cluster.

9. The one or more non-transitory computer-readable media of claim 7, wherein:
the operations further comprise determining that the first difficulty metric violates a constraint, wherein violating the constraint comprises at least one of the first difficulty metric meeting or exceeding a threshold difficulty metric or an average difficulty metric across difficulty metrics determined for other clusters; and
controlling the second vehicle based at least in part on the first difficulty metric comprises at least one of:
removing a location from a set of locations the second vehicle is permitted to use for trajectory planning;
increasing processing or memory allocation for operation planning by the second vehicle;
increasing a cost associated with a candidate trajectory or removing the candidate trajectory from a set of candidate trajectories;
increasing a number of the set of candidate trajectories;
removing a maneuver from a set of maneuvers available for controlling the second vehicle;
decreasing at least one of a maximum speed or a maximum acceleration for controlling the second vehicle;
transmitting log data comprising at least part of the sensor data to a remote computing device; or
transmitting a request for input from the remote computing device.

10. The one or more non-transitory computer-readable media of claim 7, wherein:
the operations further comprise determining that the first difficulty metric satisfies a constraint, wherein satisfying the constraint comprises at least one of the first difficulty metric being at or below a threshold difficulty metric or an average difficulty metric across difficulty metrics determined for other clusters; and
controlling the second vehicle based at least in part on the first difficulty metric comprises at least one of:
decreasing a cost associated with a candidate trajectory;
adding a location to a set of locations the second vehicle is permitted to use for trajectory planning;
adding a maneuver to a set of maneuvers available for controlling the second vehicle;
decreasing a number of a set of candidate trajectories; or
suppressing submission of log data to a remote computing device.

11. The one or more non-transitory computer-readable media of claim 7, wherein the machine-learned model is a first machine-learned model and the operations further comprise:
receiving a candidate trajectory for controlling the second vehicle;
determining, by a second machine-learned model, a predicted state of a set of objects;
determining, by the first machine-learned model and based at least in part on the predicted state, a second embedding; and
determining that the second embedding is associated with the region identified by the first cluster,
wherein controlling the second vehicle based at least in part on the first difficulty metric comprises:
discarding or increasing a cost associated with the candidate trajectory based at least in part on determining that the first difficulty metric meets or exceeds a threshold difficulty metric, or
decreasing a cost associated with the candidate trajectory based at least in part on determining that the first difficulty metric is less than the threshold difficulty metric.

12. The one or more non-transitory computer-readable media of claim 11, wherein determining the second embedding is further based at least in part on one or more of:
a preliminary cost associated with the candidate trajectory being below a threshold cost;
a layer of a tree search associated with the candidate trajectory comprises a multiple of n, where n is a positive integer; or
the candidate trajectory comprises a default candidate trajectory from among a set of default trajectories.

13. The one or more non-transitory computer-readable media of claim 7, wherein determining the embedding is associated with the region comprises determining:
the embedding is within the region,
the embedding is within a threshold distance of a portion of the region, or
the first cluster is a nearest cluster to the embedding from among the set of clusters.

14. The one or more non-transitory computer-readable media of claim 7, wherein the first difficulty metric comprises at least one of:
a first likelihood that simulating operation of the second vehicle in a first scenario of the set of scenario data will result in the second vehicle contacting an object;
a second likelihood that simulating operation of the second vehicle in the first scenario will result in an acceleration or jerk of the second vehicle that meets or exceeds a threshold acceleration or threshold jerk; or
a third likelihood that simulating operation of the second vehicle in the first scenario will result in the second vehicle idling, altering or ending a mission, or violating an operating constraint.

15. A method comprising:
receiving a set of clusters associated with an embedding space, wherein a first cluster of the set of clusters identifies a region in the embedding space associated with embeddings generated by a machine-learned model using a set of scenario data determined based at least in part on sensor data received from a first vehicle;
receiving a set of difficulty metrics associated with the set of clusters, wherein a first difficulty metric is associated with the first cluster and indicates an average predicted likelihood that an adverse event will occur during simulation of operation of a simulated vehicle in a subset of simulated scenarios associated with the first cluster;
receiving sensor data at a second vehicle;
determining, by the machine-learned model based at least in part on the sensor data, an embedding;
determining that the embedding is associated with the region identified by the first cluster; and
controlling the second vehicle based at least in part on the first difficulty metric.

16. The method of claim 15, wherein:
the machine-learned model determined embeddings for the subset of simulated scenarios;
the first cluster was determined based at least in part on the embeddings; and
the embeddings are located within the region indicated by the first cluster.

17. The method of claim 15, wherein:
the method further comprises determining that the first difficulty metric violates a constraint, wherein violating the constraint comprises at least one of the first difficulty metric meeting or exceeding a threshold difficulty metric or an average difficulty metric across difficulty metrics determined for other clusters; and
controlling the second vehicle based at least in part on the first difficulty metric comprises at least one of:
removing a location from a set of locations the second vehicle is permitted to use for trajectory planning;
increasing processing or memory allocation for operation planning by the second vehicle;
increasing a cost associated with a candidate trajectory or removing the candidate trajectory from a set of candidate trajectories;
increasing a number of the set of candidate trajectories;
removing a maneuver from a set of maneuvers available for controlling the second vehicle;
decreasing at least one of a maximum speed or a maximum acceleration for controlling the second vehicle;
transmitting log data comprising at least part of the sensor data to a remote computing device; or
transmitting a request for input from the remote computing device.

18. The method of claim 15, wherein:
the method further comprises determining that the first difficulty metric satisfies a constraint, wherein satisfying the constraint comprises at least one of the first difficulty metric being at or below a threshold difficulty metric or an average difficulty metric across difficulty metrics determined for other clusters; and
controlling the second vehicle based at least in part on the first difficulty metric comprises at least one of:
decreasing a cost associated with a candidate trajectory;
adding a location to a set of locations the second vehicle is permitted to use for trajectory planning;
adding a maneuver to a set of maneuvers available for controlling the second vehicle;
decreasing a number of a set of candidate trajectories; or
suppressing submission of log data to a remote computing device.

19. The method of claim 15, wherein the machine-learned model is a first machine-learned model and the method further comprises:
receiving a candidate trajectory for controlling the second vehicle;
determining, by a second machine-learned model, a predicted state of a set of objects;
determining, by the first machine-learned model and based at least in part on the predicted state, a second embedding; and
determining that the second embedding is associated with the region identified by the first cluster,
wherein controlling the second vehicle based at least in part on the first difficulty metric comprises:
discarding or increasing a cost associated with the candidate trajectory based at least in part on determining that the first difficulty metric meets or exceeds a threshold difficulty metric, or
decreasing a cost associated with the candidate trajectory based at least in part on determining that the first difficulty metric is less than the threshold difficulty metric.

20. The method of claim 19, wherein determining the second embedding is further based at least in part on one or more of:
a preliminary cost associated with the candidate trajectory being below a threshold cost;
a layer of a tree search associated with the candidate trajectory comprises a multiple of n, where n is a positive integer; or
the candidate trajectory comprises a default candidate trajectory from among a set of default trajectories.
